(19) United States
(12) Patent Application Publication
(10) Pub. No.: US 2014/0255840 A1
(43) Pub. Date: Sep. 11, 2014

(54) TONER FOR ELECTROPHOTOGRAPHY, AND IMAGE FORMING METHOD, IMAGE FORMING APPARATUS AND PROCESS CARTRIDGE USING THE TONER

(71) Applicants: Yoshitaka SEKIGUCHI, Shizuoka (JP); Hisashi Nakajima, Shizuoka (JP); Masashi Nagayama, Shizuoka (JP); Saori Yamada, Shizuoka (JP); Shinya Hanatani, Kanagawa (JP); Mariko Takii, Kanagawa (JP)

(72) Inventors: Yoshitaka SEKIGUCHI, Shizuoka (JP); Hisashi Nakajima, Shizuoka (JP); Masashi Nagayama, Shizuoka (JP); Saori Yamada, Shizuoka (JP); Shinya Hanatani, Kanagawa (JP); Mariko Takii, Kanagawa (JP)

(21) Appl. No.: 14/167,096

(22) Filed: Jan. 29, 2014

(30) Foreign Application Priority Data
Mar. 7, 2013 (JP) 2013-045464

(51) Int. Cl. G03G 9/00

(52) U.S. Cl. CPC G03G 9/08755; G03G 21/18; G03G 15/08
USPC 430/105; 430/108.23

(57) ABSTRACT

A toner is provided. The toner includes a crystalline polyester resin (A); and a non-crystalline resin (B). The toner has a viscoelastic property such that the loss tangent (tan δ) defined as a ratio (G″/G′) of loss elastic modulus (G″) to storage elastic modulus (G′) has at least an inflection point or a local maximal point at a temperature α in a temperature range of from 65° C. to 80° C. while having a local maximal point at a temperature β in a temperature range of from 75° C. to 90° C., wherein the loss tangent at the temperature α is from 1.2 to 2.0, and the loss tangent at the temperature β is from 1.0 to 2.5, wherein the temperature α is lower than the temperature β.

### CROSS-REFERENCE TO RELATED APPLICATIONS

This patent application is based on and claims priority pursuant to 35 U.S.C. §119 to Japanese Patent Application No. 2013-045464 filed on Mar. 7, 2013 in the Japan Patent Office, the entire disclosure of which is hereby incorporated by reference herein.

### TECHNICAL FIELD

This disclosure relates to a toner for electrophotography. In addition, this disclosure also relates to an image forming method, an image forming apparatus, and a process cartridge using the toner.

### BACKGROUND

Recently, toner for use in electrophotography is required to be fixed at a relatively low fixing temperature so that the energy used for electrophotographic image forming apparatus can be reduced by reducing the fixing energy, and the image forming apparatus can produce high quality images at a relatively high speed.

In general, as the image forming speed of an electrophotographic image forming apparatus increases, the quality of images produced by the apparatus worsens. The major factor of deterioration of image quality in high speed image formation is that images are defectively fixed in a fixing process.

In a fixing process, an unfixed toner image is fixed to a recording medium typified by paper upon application of heat and pressure thereto. In this regard, if the system speed (image forming speed) is increased, a sufficient amount of heat cannot be applied to the unfixed toner image. Therefore, a defectively fixed toner image with a roughened surface is formed, and a cold offset problem in that part of a toner image on a recording medium sheet is transferred to a fixing member of the fixing device at a low fixing temperature, and the transferred image is transferred again to another portion of the recording medium sheet or another recording medium sheet, resulting in formation of defective images is caused. Therefore, when the system speed is increased, the fixing temperature is typically raised so as not to deteriorate the image quality. However, in this case, problems such that image forming processes other than the fixing process are adversely affected by the heat leaked from the fixing device; the lives of parts of the fixing device are shortened; and energy consumption increases are caused. Therefore, increase of the fixing temperature is not necessarily the best remedy.

Therefore, a need exists for a toner which has good fixability even when being used for high speed image forming apparatus. Specifically, a need exists for a toner having good fixability at a relatively low fixing temperature.

In attempting to improve fixability of toner, various methods have been proposed. For example, methods in which thermal properties of a resin included in toner, such as glass transition temperature (Tg) and softening point (T1/2), are controlled have been proposed. However, the methods in which a resin having a low glass transition temperature is used for toner have a drawback such that the high temperature preservability of the toner deteriorates. In addition, the methods in which a resin having a low molecular weight is used for toner to decrease the softening point (T1/2) of the toner have a drawback such that a hot offset problem in that part of a toner image on a recording medium sheet is transferred to a fixing member of the fixing device at a high fixing temperature, and the transferred image is transferred again to another portion of the recording medium sheet or another recording medium sheet, resulting in formation of defective images is caused. Therefore, toner having a good combination of low temperature fixability, high temperature preservability, and hot offset resistance cannot be prepared only by controlling thermal properties of a resin used for the toner.

JP-4530376-B1 (i.e., WO2009/011424) proposes a toner which has a storage elastic modulus of from 5.00×10⁷ to 1.00×10⁹ at a temperature in a temperature range of from 50 to 80° C., at which the loss tangent (tan δ) has a local maximal value. In addition, the toner has a property such that the width of the temperature range in which the loss tangent (tan δ) of the toner falls in a range of from 0.80 to 2.00 in the temperature range of from 50 to 80° C. is not less than 15° C. The object of the application is to provide a toner which has good low temperature fixability while having good toughness so as not to contaminate parts around a developing device and which has small variation in frictional charging property, and good durability.

JP-4920973-B1 (i.e., JP-2007-183382-A) proposes a toner which has a specific storage elastic modulus at temperatures of 110° C. and 150° C. while having a local maximal value of loss tangent (tan δ) in each of a temperature range of from 68° C. to 85° C. and a temperature range of from 110° C. to 135° C. The purpose of the application is to provide a toner which can stably produce images having constant image density without causing background development and contamination of a charger and a developing blade while having a good combination of fixability and glossiness imparting property even when being used high speed image formation.

JP-4560587-B1 (i.e., WO2009/107830) proposes a toner which has a local maximal value of loss tangent (tan δ) of not less than 0.50 in a temperature range of from 28° C. to 60° C. while having a local minimal value of loss tangent (tan δ) of not greater than 0.60 in a temperature range of from 45° C. to 85° C. The purpose of the application is to provide a toner which has a good combination of low temperature fixability, developing stability, penetration resistance, and color gamut property and which can produce high quality images. JP-2002-131969-A proposes a color toner which has a specific storage elastic modulus at temperatures of 90° C. and 140° C. and which has a local maximal value of loss tangent (tan δ) of not less than 1.33 in a temperature range of from 90° C. to 120° C. The purpose of the application is to provide a toner which does not cause the cold and hot offset problems even when the toner is used for a fixing device in which a small amount of oil is applied to the fixing member.

JP-2001-223138-A proposes a toner for which a crystalline polyester resin is used.

JP-2004-46095-A proposes a toner in which a crystalline polyester resin and a non-crystalline polyester resin insoluble in the crystalline polyester resin form a sea-island phase separation structure.

JP-2007-33773-A proposes a toner which has a specific endothermic peak in a differential scanning calorimetry (DSC) curve to control the state of a crystalline polyester resin therein so that the toner can has a good combination of low temperature fixability and high temperature preservability.

JP-2005-338814-A proposes a toner which includes a crystalline polyester resin in a relatively large amount.

JP-4118498-B1 (i.e., JP-2002-82484-A) proposes a technique such that the peak and half width of the molecular weight distribution of the toner are specified, the amount of chloroform insoluble components in the toner is specified, and resins having different softening points are used as the binder resin of the toner.

JP-2007-206097-A proposes a technique such that the ratio of the peak height of the spectrum of FTIR (Fourier transform infrared spectroscopy) of a crystalline polyester resin in a toner to the peak height of the spectrum of FTIR of a non-crystalline polyester resin in the toner after the toner is preserved for 12 hours at 45° C. is specified.

The present inventors recognize that a need exists for a toner which has a good combination of low temperature fixability, hot offset resistance, and preservation stability and which can produce high quality images over a long period of time.

### SUMMARY

As an aspect of this disclosure, a toner is provided which includes a crystalline polyester resin (A) and a non-crystalline resin (B) while including a tetrahydrofuran(THF)-soluble component and a chloroform-insoluble component and which has an infrared absorption property such that when the toner is preserved for 12 hours at 45° C. and then subjected to an attenuated total reflection Fourier transform infrared spectroscopic analysis (ATR-FTIR), the ratio (C/R) of the height (C) of a peak specific to the crystalline polyester resin (A) to the height (R) of another peak specific to the non-crystalline polyester resin (B) is from 0.03 to 0.55. The THF soluble component has a molecular weight distribution curve obtained by gel permeation chromatography (GPC) such that a main peak is present in a range of from 1,000 to 10,000, and the half width of the main peak is not greater than 20,000. The toner has a viscoelastic property such that the curve of loss tangent (tan δ) defined as a ratio (G″/G′) of loss elastic modulus (G″) to storage elastic modulus (G′) has at least an inflection point or a local maximal point at a temperature α in a temperature range of from 65° C. to 80° C. while having a local maximal point at a temperature β in a temperature range of from 75° C. to 90° C., wherein the value of tan δ at the temperature α is from 1.2 to 2.0, and the value of tan δ at the temperature is from 1.0 to 2.5, wherein the temperature α is lower than the temperature β.

As another aspect of this disclosure, an image forming method is provided which includes forming an electrostatic latent image on an image bearing member; and developing the electrostatic latent image with a developer including the toner mentioned above to prepare a toner image on the image bearing member.

As another aspect of this disclosure, an image forming apparatus is provided which includes an image bearing member; a charger to charge a surface of the image bearing member; an irradiator to irradiate the charged surface of the image bearing member with light to form an electrostatic latent image on the image bearing member; a developing device to develop the electrostatic latent image with a developer including the toner mentioned above to form a toner image on the image bearing member; and a transferring device to transfer the toner image to a recording medium.

As another aspect of this disclosure, a process cartridge is provided which includes at least an image bearing member to bear an electrostatic latent image thereon; and a developing device to develop the electrostatic latent image with a developer including the toner mentioned above to form a toner image on the image bearing member. The image bearing member and the developing device are integrated as a unit so as to be detachably attachable to an image forming apparatus.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1 illustrates the viscoelasticity curve of a toner according to an embodiment;

FIG. 2 illustrates the viscoelasticity curve of another toner according to an embodiment;

FIG. 3 illustrates the viscoelasticity curve of a conventional toner:

FIG. 4 illustrates a FTIR spectrum of a crystalline polyester resin (A) in which a peak is observed at wavelength of 1183 cm⁻¹ while having a height of C and a base line of from 1158 to 1201 cm⁻¹;

FIG. 5 illustrates a FTIR spectrum of a non-crystalline resin (B) (polyester resin) in which a peak is observed at wavelength of 829 cm⁻¹ while having a height of R and a base line of from 784 to 889 cm⁻¹;

FIG. 6 illustrates a FTIR spectrum of another non-crystalline resin (B) (styrene-acrylic resin) in which a peak is observed at wavelength of 699 cm⁻¹ while having a height of R and a base line of from 670 to 714 cm⁻¹;

FIG. 7 illustrates an X-ray diffraction spectrum of a crystalline polyester resin a-6 used for Example 26;

FIG. 8 illustrates an X-ray diffraction spectrum of a toner of Example 30;

FIG. 9 is a schematic view illustrating an image forming apparatus according to an embodiment;

FIG. 10 is a schematic view illustrating a portion of another image forming apparatus according to an embodiment;

FIG. 11 is a schematic view illustrating another image forming apparatus according to an embodiment;

FIG. 12 is a schematic view illustrating another image forming apparatus according to an embodiment; and

FIG. 13 is a schematic view illustrating a process cartridge according to an embodiment.

### DETAILED DESCRIPTION

The above-mentioned toner disclosed by JP-4530376-B1 (WO2009/011424) has a large storage elastic modulus at the temperature in which the loss tangent (tan δ) has a maximal value, and therefore the toner has insufficient low temperature fixability.

In the above-mentioned toner disclosed by JP-4920973-B1 (JP-2007-183382-A), the temperature at which the loss tangent (tan δ) has a second maximal value is high, and therefore the toner has insufficient low temperature fixability.

In the above-mentioned toner disclosed by JP-4560587-B1 (WO2009/107830), the minimal value of the loss tangent (tan δ) is too small, and therefore the elasticity is superior to the viscosity just after the toner is melted. Therefore, the toner has insufficient low temperature fixability.

In the above-mentioned toner disclosed by JP-2002-131969-A, the temperature range in which the loss tangent (tan δ) has a minimal value is high, and therefore the toner has insufficient low temperature fixability. In addition, the toner has insufficient elasticity in a high temperature range, and therefore the temperature range in which the toner can be used for oil-less fixing is narrow.

In the above-mentioned toner disclosed by JP-2001-222138-A, the molecular weight of the toner and the state of the crystalline polyester resin are not optimized. Therefore, the low temperature fixability and the high temperature fixability of the crystalline polyester resin are not necessarily imparted to the toner. In addition, a measure against hot offset resistance is not taken, and therefore the toner does not necessarily have a wide fixable temperature range.

In the above-mentioned toner disclosed by JP-2004-46095-A, three kinds of resins including a crystalline polyester resin are used. When preparing a sea-island structure using the crystalline polyester resin, the diameter of the island tends to increase. In this case, good high temperature preservability is not necessarily imparted to the toner. In addition, the electric resistance of the toner tends to deteriorate, and therefore defective transferring of toner images may be caused.

In the above-mentioned toner disclosed by JP-2007-33773-A, a resin having a relatively high softening point is used as the non-crystalline polyester resin in combination with a crystalline polyester resin. In this case, the low temperature fixability is to be imparted to the toner by the crystalline polyester resin, and therefore the added amount of the crystalline polyester resin increases. Accordingly, a risk such that compatibility of the crystalline polyester resin with the non-crystalline resin is enhanced, thereby deteriorating the high temperature preservability of the toner tends to grow.

The above-mentioned toner disclosed by JP-2005-338814-A includes a crystalline polyester resin in a very large amount, and therefore a risk such that compatibility of the crystalline polyester resin with the non-crystalline resin is enhanced, thereby deteriorating the high temperature preservability of the toner tends to grow.

The above-mentioned toner disclosed by JP-4118498-B1 (JP-2002-82484-A) does not include a crystalline polyester resin, and therefore the toner does not necessarily have good low temperature fixability.

In the above-mentioned toner disclosed by JP-2007-206097-A, the molecular weight of the resins is not specified, and therefore the low temperature fixability is to be imparted to the toner only by the crystalline polyester resin. Therefore, the toner does not necessarily have good low temperature fixability. In addition, a measure against hot offset resistance is not described therein, and therefore the toner does not necessarily have a wide fixable temperature range.

The object of this disclosure is to provide a toner which has a good combination of low temperature fixability, hot offset resistance, and preservation stability and which can produce high quality images over a long period of time.

As a result of the present inventors' investigation, it is found that by controlling the loss tangent (tan δ) (i.e., the ratio (G″/G′) of loss elastic modulus (G″) to storage elastic modulus (G′)) so as to fall in a predetermined range, the above-mentioned problems can be solved.

The toner of this disclosure includes a crystalline polyester resin (A) and a non-crystalline resin (B) while including a tetrahydrofuran(THF)-soluble component and a chloroform-insoluble component and which has a property such that when the toner is preserved for 12 hours at 45° C. and then subjected to an attenuated total reflection Fourier transform infrared spectroscopic analysis (ATR-FTIR), the ratio (C/R) of the height (C) of the peak specific to the crystalline polyester resin (A) to the height (R) of the peak specific to the non-crystalline polyester resin (B) is from 0.03 to 0.55. The toner is characterized in that the THF soluble component has a molecular weight distribution determined by gel permeation chromatography (GPC) such that a main peak is present in a range of from 1,000 to 10,000, and the half width of the main peak is not greater than 20,000. In addition, the toner has a viscoelastic property such that the curve of loss tangent (tan δ) defined as a ratio (G″/G′) of loss elastic modulus (G″) to storage elastic modulus (G′) has at least an inflection point or a local maximal point at a temperature α in a temperature range of from 65° C. to 80° C. while having a local maximal point at a temperature β in a temperature range of from 75° C. to 90° C., wherein the value of tan δ at the temperature α is from 1.2 to 2.0, and the value of tan δ at the temperature β is from 1.0 to 2.5, wherein the temperature α is lower than the temperature β.

Next, the toner, the image forming method and apparatus, and the process cartridge will be described in detail.

As mentioned above, toner for use in electrophotography is required to be fixed at a relatively low fixing temperature so that the energy used for electrophotographic image forming apparatus can be reduced by reducing the fixing energy, and the image forming apparatus can produce high quality images at a relatively high speed. This is because electrophotographic image forming apparatuses are used for various purposes.

By decreasing the softening point of toner, the toner has good low temperature fixability. However, when the softening point of toner is decreased, the glass transition temperature of the toner also decreases, resulting in deterioration of the high temperature preservability of the toner. In addition, in this case, not only the lower fixable temperature of the toner is decreased, but also the higher fixable temperature of the toner is decreased, resulting in deterioration of the hot offset resistance of the toner. Therefore, it is a difficult problem to impart a good combination of low temperature fixability, high temperature preservability and hot offset resistance to toner.

The present inventors have diligently researched to solve the problem. As a result, the present inventors discover the following technology, and thereby the problem mentioned above can be solved.

When a crystalline polyester resin is used as a binder resin of toner, a good combination of low temperature fixability and high temperature preservability can be imparted to the toner because such a crystalline polyester resin has sharp melting property.

However, when only a crystalline polyester resin is used as a binder resin of toner, the hot offset resistance of the toner seriously deteriorates, and therefore the fixable temperature range of the toner narrows. Namely, the toner is useless.

The present inventors consider that by using a crystalline polyester resin (A) and a non-crystalline resin (B) including a chloroform-insoluble component for toner, the hot offset resistance of the toner can be enhanced, and therefore the fixable temperature range of the toner can be widened.

However, when only a crystalline polyester resin (A) and a non-crystalline resin (B) are used, the low temperature fixability of the toner tends to deteriorate if the amount of the non-crystalline resin (B) is large. In contrast, if the amount of the crystalline polyester resin (A) is large, the crystalline polyester resin (A) tends to be mixed with components of the non-crystalline resin (B) other than the chloroform-insoluble component in a kneading process in which toner components are heated while kneaded to prepare a toner composition block. In this case, the glass transition temperature of the crystalline resin (A) seriously decreases, thereby seriously deteriorating the high temperature preservability of the toner.

As a result of the present inventors' diligent research, it is found that when the THF soluble component has a molecular weight distribution determined by gel permeation chromatography (GPC) such that a main peak is present in a range of from 1,000 to 10,000, and the half width of the main peak is not greater than 20,000, the amount of low molecular-weight components in the toner can be increased while the molecular weight distribution of the resin components can be sharpened. In addition, the content of the crystalline polyester resin (A) can be reduced, and thereby mixing of the crystalline polyester resin (A) and the non-crystalline resin (B) can be prevented. Therefore, the low temperature fixability of the crystalline polyester resin (A) and the hot offset resistance of the non-crystalline resin (B) can be satisfactorily exerted.

However, even in this case, it is impossible to perfectly eliminate the risk of deterioration of the high temperature preservability. Specifically, even when mixing of the crystalline polyester resin (A) and the non-crystalline resin (B) and decrease of the glass transition temperature of the binder resin are prevented, the crystalline polyester resin (A) tends to be mainly present on the surface of toner particles if the crystalline polyester resin (A) dispersed in the toner has a large particle diameter. Since the crystalline polyester resin (A) has sharp melting property, good high temperature preservability can be imparted to the toner if the crystalline polyester resin (A) is present inside toner particles. However, even at a temperature lower than the glass transition temperature of the crystalline polyester resin (A), the viscosity of the resin (A) slightly decreases (the resin slightly softens). Therefore, if the crystalline polyester resin (A) is present on the surface of toner particles, the toner particles tend to adhere to each other, resulting in deterioration of high temperature preservability. This phenomenon prominently occurs in crystalline polyester resins having a low crystallinity.

In addition, when the crystalline polyester resin (A) is excessively present on the surface of toner particles, a filming problem in that a film of toner is formed of a photoreceptor such as OPCs (organic photoconductors) tends to be caused, resulting in deterioration of image quality.

The present inventors discover that when the above-mentioned conditions are satisfied while satisfying a condition such that the toner has a viscoelastic property such that the curve of loss tangent (tan δ) defined as a ratio (G″/G′) of loss elastic modulus (G″) to storage elastic modulus (G′) has at least an inflection point or a local maximal point at a temperature α in a temperature range of from 65° C. to 80° C. while having a local maximal point at a temperature β in a temperature range of from 75° C. to 90° C., wherein the value of tan δ at the temperature α is from 1.2 to 2.0, and the value of tan δ at the temperature β is from 1.0 to 2.5, wherein the temperature α is lower than the temperature β, the toner has a good combination of low temperature fixability and high temperature preservability.

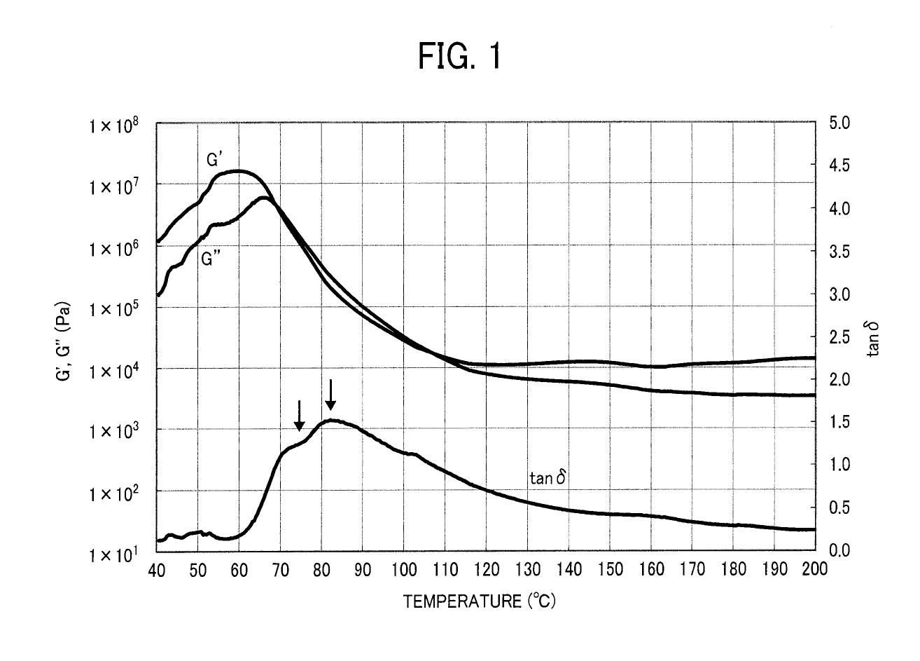

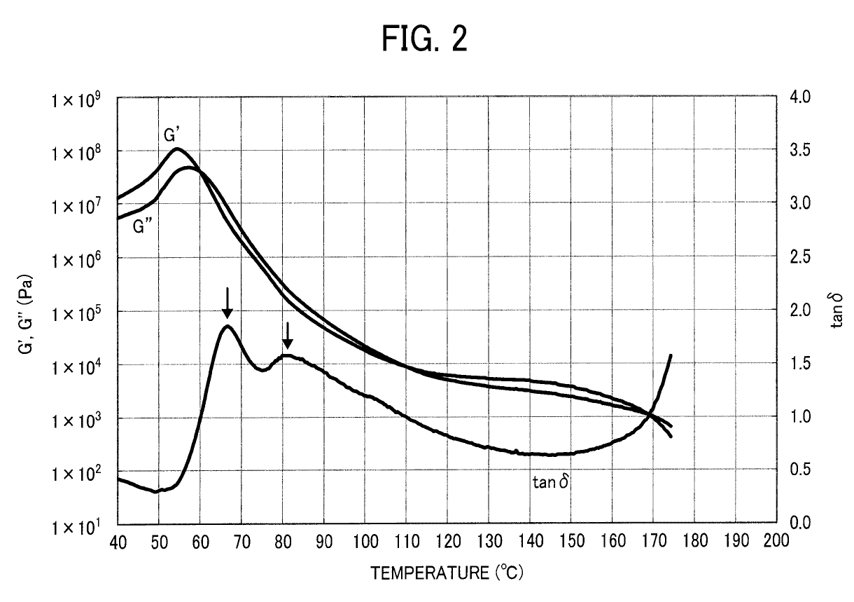

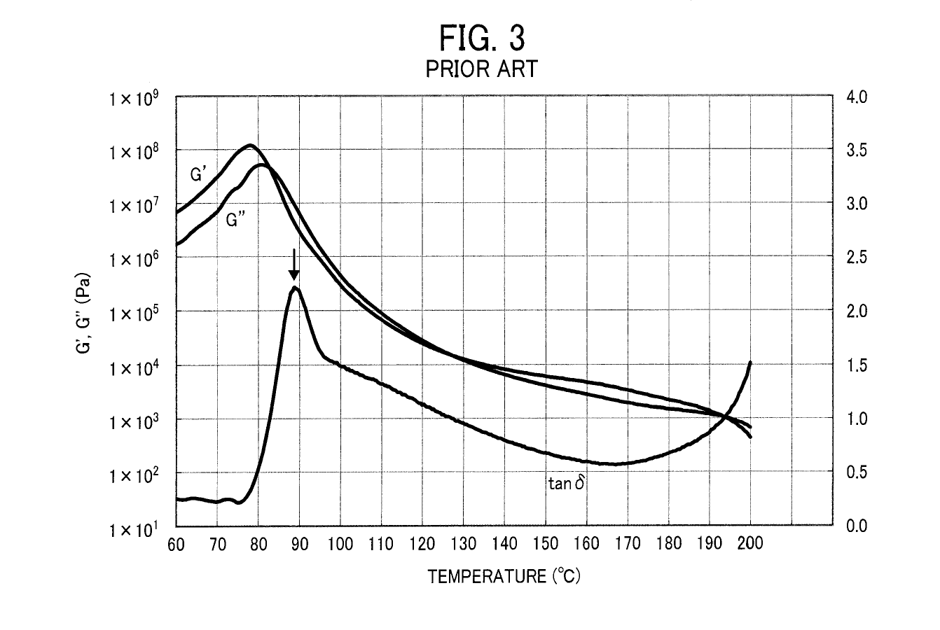

The loss tangent (tan δ) is defined as a ratio (G″/G′) of loss elastic modulus (G″) to storage elastic modulus (G′). Viscoelasticity curves of toners of this disclosure are illustrated in FIGS. 1 and 2, and a viscoelasticity curve of a conventional toner is illustrated in FIG. 3.

In the viscoelasticity curve illustrated in FIG. 1, the tan δ curve has an inflection point at a temperature of 72.2° C. (i.e., in a temperature range of from 65° C. to 80° C.) as indicated by a left arrow. Namely, the temperature α is 72.2° C. In addition, the tan δ curve has a local maximal point at 82° C. (i.e., in a temperature range of from 75° C. to 90° C.) as indicated by a right arrow. Namely, the temperature β is 82° C.

In the viscoelasticity curve illustrated in FIG. 2, the tan δ curve has a local maximal point at 68° C. (i.e., in a temperature range of from 65° C. to 80° C.) as indicated by a left arrow. Namely, the temperature α is 68° C. In addition, the tan δ curve has another local maximal point at 82.5° C. (i.e., in a temperature range of from 75° C. to 90° C.) as indicated by a right arrow. Namely, the temperature β is 82.5° C.

In the viscoelasticity curve illustrated in FIG. 3, the tan δ curve has a local maximal point at a temperature in a temperature range of from 75° C. to 90° C. as indicated by an arrow, but has no inflection point or local maximal point in a temperature range of from 65° C. to 80° C. Therefore, the toner is not the toner of this disclosure. As mentioned later in detail, the inflection point or local maximal point in a temperature range of from 65° C. to 80° C. is specific to a crystalline polyester resin (A), and therefore a toner including no crystalline polyester resin (A) typically has such a viscoelasticity curve as illustrated in FIG. 3.

A local maximal point of tan δ appearing in a temperature range of from 75° C. to 90° C. of a viscoelasticity curve is specific to melting or softening of a non-crystalline resin (B). In order to impart a good combination of low temperature fixability and high temperature preservability to toner, the temperature β at which the tan δ has a maximal point preferably falls in a temperature range of from 75° C. to 90° C., and more preferably from 75° C. to 85° C. The temperature β can be controlled by adjusting the glass transition temperature or melt starting temperature of the non-crystalline resin (B) used.

When the temperature β is lower than 75° C., the high temperature preservability of the toner tends to deteriorate. In contrast, when the temperature β is higher than 90° C., the melting point of the non-crystalline resin (B) becomes much higher than that of the crystalline polyester resin (A), the low temperature fixability of the toner tends to deteriorate.

In addition, the value of tan δ at temperature β is preferably from 1.0 to 2.5, and more preferably from 1.2 to 2.0. When the value of tan δ at temperature β is less than 1.0, the storage elastic modulus increases, i.e., the ratio of the elastic component increases, and thereby problems such that the low temperature fixability of the toner deteriorates, and strength of a fixed toner image deteriorates are often caused. In contrast, when the value of tan δ at temperature β is greater than 2.5, the loss elastic modulus increases, i.e., the ratio of the viscous component increases, and thereby a problem such that the internal cohesion force of the toner decreases, and part of a toner image is released in a fixing process, thereby contaminating a fixing member is often caused.

One or more non-crystalline resins can be used as the non-crystalline resin (B). When two or more non-crystalline resins are used, the tan δ curve can have plural local maximal points at different temperatures in a temperature range of from 75° C. to 90° C. In this case, when the value of tan δ is from 1.0 to 2.5 at least at one of the local maximal points, the effect of this disclosure can be produced. It is more preferable that the value of tan δ is not greater than 2.5 at any one of the local maximal points. If the value of tan δ is greater than 2.5 at one of the local maximal points, the high temperature preservability of the toner tends to deteriorate. When the value of tan δ at one of the local maximal points is from 1.0 to 2.5 and the value of tan δ at another local maximal point is less than 1.0, the toner can be practically used although the low temperature fixability of the toner may slightly deteriorate.

In the viscoelasticity curve, the inflection point or local maximal point in a temperature range of from 65° C. to 80° C. is specific to change in crystal structure, melting or softening of a crystalline polyester resin (A). The temperature α can be controlled by adjusting the crystallization temperature, glass transition temperature, or melt starting temperature of the crystalline polyester resin (A) or the state of the crystalline polyester resin (A) in the toner (i.e., the diameter of the crystalline polyester resin (A) dispersed in the toner). The tan δ curve may have an inflection point or a local maximal point in the temperature range of from 65° C. to 80° C. However, a case in which the tan δ curve has a local maximal point in the temperature range is preferable because the effect caused by change in crystal structure of the crystalline polyester resin (A) becomes dominant over the effect of the non-crystalline resin (B), thereby enhancing the low temperature fixability of the toner. In contrast, in a case in which the tan δ curve has an inflection point in the temperature range, the high temperature preservability of the toner can be enhanced while the effect of the crystalline polyester resin (A) to enhance the low temperature fixability is produced.

When the crystalline polyester resin (A) and the non-crystalline resin (B) are perfectly mixed with each other, the tan δ curve does not have an inflection point or a local maximal point in the temperature range of from 65° C. to 80° C. In this case, good low temperature fixability cannot be imparted to the toner. In addition, in a case in which the crystalline polyester resin (A) has insufficient crystallinity, the tan δ curve does not have a local maximal point in the temperature range of from 65° C. to 80° C., and therefore good low temperature fixability cannot be imparted to the toner.

When the diameter of the crystalline polyester resin (A) dispersed in the toner becomes too large, chance of appearance of the crystalline polyester resin (A) from the surface of toner particles increases. Therefore, change in crystal structure of the crystalline polyester resin (A) tends to occur at a relatively low temperature, and therefore the tan δ curve tends to have an inflection point or a local maximal point at a temperature lower than 65° C., thereby deteriorating the high temperature preservability of the toner. This phenomenon also occurs in a case in which the added amount of the crystalline polyester resin (A) is excessively large.

When the temperature α at which the tan δ curve has an inflection point or a local maximal point specific to the crystalline polyester resin is higher than 80° C., the temperature becomes close to the temperature at which the non-crystalline resin (B) starts to perform glass transition or melting, and therefore it becomes hard to impart good low temperature fixability to the toner. In addition, when the temperature α is not lower than the temperature β at which the tan δ curve has a local maximal point specific to the non-crystalline resin (B), the effect of the crystalline polyester resin (A) cannot be produced, namely good low temperature fixability cannot be imparted to the toner. Therefore, it is necessary for the toner of this disclosure to satisfy the relation, α<β.

The value of the tan δ is preferably from 1.2 to 2.0, and more preferably from 1.3 to 1.8, at the temperature α. When the value of the tan δ is less than 1.2, the storage elastic modulus increases (i.e., the ratio of the elastic component increases), and therefore it becomes hard to impart good low temperature fixability to the toner. In contrast, when the value of the tan δ is greater than 2.0, the loss elastic modulus increases (i.e., the ratio of the viscous component increases), and therefore the melting speed of the crystalline polyester resin (A) increases, resulting in deterioration of the high temperature fixability of the toner.

It is possible to use plural crystalline polyester resins (A). In this case, the tan δ curve may have plural inflection points or local maximal points at different temperatures. In this case, if the value of the tan δ is from 1.2 to 2.0 at least at one of the temperatures, the above-mentioned effect can be produced. It is more preferable that both the values of the tan δ are not greater than 2.0. If the value of the tan δ is greater than 2.0 at least at one of the temperatures, the high temperature preservability of the toner may deteriorate. Even in a case in which the value of the tan δ is from 1.2 to 2.0 at least at one of the temperatures and the value of the tan δ is less than 1.2 at the other temperature, the toner is usable although the low temperature fixability of the toner may slightly deteriorate.

The loss tangent (tan δ) of a toner can be measured by a viscoelastic measuring method. In this disclosure, the following method is used. Specifically, 0.8 g of a toner is pelletized at a pressure of 30 MPa using a die with a diameter of 20 mm. The loss elastic modulus (G″), storage elastic modulus (G′) and loss tangent (tan δ) of the pellet are measured with an instrument, ADVANCED RHEOMETRIC EXPANSION SYSTEM from TA Instrument, under the following conditions.

Parallel cone used: Parallel cone with a diameter of 20 mm

Frequency: 1.0 Hz

Temperature rising speed: 2.0° C./min

Strain: 0.1% (Automatic strain control, allowable minimum stress: 1.0 g/cm, allowable maximum stress of 500 g/cm, maximum addition strain of 200%, and strain adjustment of 200%)

GAP: GAP is adjusted in such a manner that after the sample is set to the instrument, FORCE falls in a range of from 0 to 100 gm.

Thus, the loss tangent (tan δ) of the toner is determined.

When a kneaded mixture of toner components, in which the crystalline polyester resin (A) is dispersed while having a relatively small particle diameter, is pulverized to prepare toner particles, chance of appearance of the crystalline polyester resin (A) on the surface of the toner particles decreases, thereby dramatically enhancing the high temperature preservability of the toner. In addition, the toner particles have a proper electric resistance because the crystalline polyester resin (A) is finely dispersed.

However, even when toner components including a crystalline polyester resin (A) and a non-crystalline resin (B) are melted and kneaded in the toner production process, there is a case in which advantages of the resins (A) and (B) cannot be taken. This is because the molecular chains of the resins are cut in the kneading process and thereby the molecular weight of the resins is changed. Particularly, when the molecular chains of the chloroform-insoluble components included in the non-crystalline resin (B) are cut, the molecular weight distribution of the toner becomes broad, thereby deteriorating the low temperature fixability of the toner.

As a result of the present inventors' diligent research, it is found that the advantages of the resins (A) and (B) can be taken (i.e., a good combination of low temperature fixability, high temperature preservability and hot offset resistance can be imparted to the toner) by the following method.

Specifically, a method including subjecting toner components including a crystalline polyester resin (A) and a non-crystalline resin (B) to a kneading treatment while properly heating the toner components to apply a proper shear stress to the toner components, and then subjecting the kneaded toner components to a cooling process so that the crystalline polyester resin is re-crystallized is preferably used. Use of this method makes it possible to prepare a toner including low molecular weight components in a relatively large amount while having a sharp molecular weight distribution such that the THF-soluble components of the toner have a molecular weight distribution determined by gel permeation chromatography (GPC) such that a main peak is present in a range of from 1,000 to 10,000, and the half width of the main peak is not greater than 20,000.

Whether or not the effect of the crystalline polyester resin (A) can be produced depends on the amount of the crystalline polyester resin (A) present on the surface of toner particles, and therefore it is preferable to properly adjust the added amount of the crystalline polyester resin (A), the dispersion state of the crystalline polyester resin (A) dispersed in the toner, and the method for kneading the toner components so that the above-mentioned conditions are satisfied. Thus, the amount of the crystalline polyester resin (A) present on the surface of toner particles can be optimized. By using this method, a good combination of low temperature fixability and high temperature preservability can be imparted to the toner while preventing occurrence of the above-mentioned filming problem.

The amount of a crystalline polyester resin (A) present on the surface of toner particles can be determined from the peak height ratio in a spectrum obtained by subjecting the toner to an attenuated total reflection Fourier transform infrared spectroscopic analysis (ATR-FTIR). As a result of the present inventors' investigation, it is found that the state of toner in high temperature transporting (such as transporting using a ship) corresponds to the state of the toner preserved for 12 hours at 45° C. Therefore, the present inventors discover that when the ratio (C/R) of the peak height (C) of an ATR-FTIR spectrum specific to the crystalline polyester resin (A) to the peak height (R) of an ATR-FTIR spectrum specific to the non-crystalline resin (B) falls in a range of from 0.03 to 0.55 after the toner is preserved for 12 hours at 45° C., a good combination of low temperature fixability and high temperature preservability can be imparted to the toner while preventing occurrence of the above-mentioned filming problem.

When the peak height ratio (C/R) is greater than 0.55, the amount of the crystalline polyester resin (A) present on the surface of toner particles is too large, and therefore the high temperature preservability of the toner and the resistance thereof to the filming problem deteriorate. In contrast, when the peak height ratio (C/R) is less than 0.03, the amount of the crystalline polyester resin (A) present on the surface of toner particles is too small, and therefore the low temperature fixability of the toner deteriorates.

As mentioned above, the amount of the crystalline polyester resin (A) present on the surface of toner particles, i.e., the peak height ratio (C/R), can be adjusted by properly adjusting the added amount of the crystalline polyester resin (A), the dispersion state of the crystalline polyester resin (A) dispersed in the toner, and the method for kneading the toner components. For example, by increasing the added amount of a crystalline polyester resin (A), the ratio (C/R) can be increased. In addition, by prolonging the cooling time (i.e., by performing gradually cooling) after a kneading process of the toner components, the crystalline polyester resin (A) is well re-crystallized, and thereby the ratio (C/R) can be increased. The method for adjusting the ratio (C/R) is not limited thereto, and any methods can be used as long as the ratio (C/R) can be adjusted so as to fall in the range of from 0.03 to 0.55.

In this application, the peak height is determined from an ATR-FTIR spectrum obtained by a Fourier transform infrared spectrometer using an ATR method, AVATAR 370 from Thermo Electron. Since it is necessary for the ATR-FTIR method that the surface of the sample is smooth, the sample (toner) is pelletized and the pellet is used for the measurement. In the pelletizing process, a load of 1,000 kg is applied for 30 seconds to 0.6 g of a toner to prepare a pellet with a diameter of 20 mm.

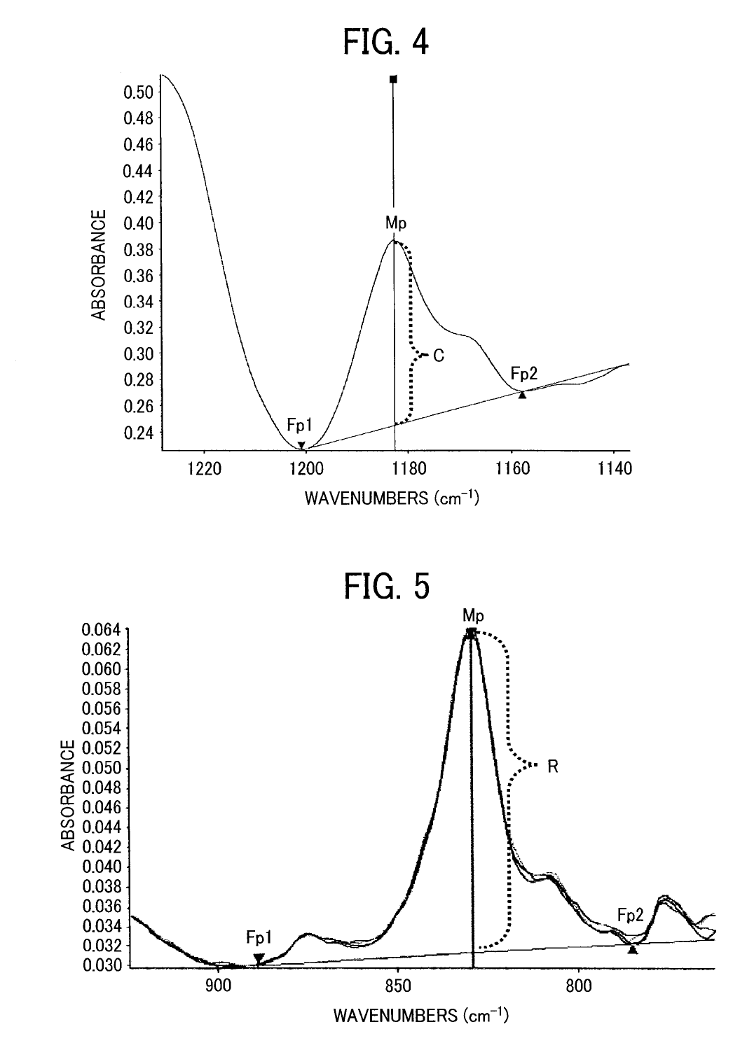

FIG. 4 illustrates the infrared absorption spectrum of a crystalline polyester resin. As illustrated in FIG. 4, the infrared absorption spectrum of a crystalline polyester resin is characterized in that a rising peak having a maximum absorbance (hereinafter referred to as a maximum rising peak Mp) is present between a falling peak having a minimum absorbance (hereinafter referred to as a first falling peak Fp1) observed in a wavenumber range of from 1130 cm⁻¹ to 1220 cm⁻¹, and a falling peak having a second-minimum absorbance (hereinafter referred to as a second falling peak Fp2) observed in a wavenumber range of from 1130 cm⁻¹ to 1220 cm⁻¹. In this regard, a line obtained by connecting the first and second falling peaks Fp1 and Fp2 is the base line. In addition, the difference in absorbance between the maximum rising peak Mp and an intersection of the base line with a vertical line passing the maximum rising peak is defined as the height (C) of the maximum rising peak Mp.

In the infrared absorption spectrum illustrated in FIG. 4, the first falling peak Fp1 is present at 1158 cm⁻¹, the second falling peak Fp2 is present at 1201 cm⁻¹, the base line ranges from 1158 cm⁻¹ to 1201 cm⁻¹, and the maximum rising peak Mp is present at 1183 cm⁻¹.

FIG. 5 illustrates the infrared absorption spectrum of a non-crystalline polyester resin. As illustrated in FIG. 5, the infrared absorption spectrum of a non-crystalline polyester resin is characterized in that a maximum rising peak Mp, a first falling peak Fp1, and a second falling peak Fp2 are present in a wavenumber range of from 780 cm⁻¹ to 900 cm⁻¹, and the maximum rising peak Mp is present between the first and second falling peaks Fp1 and Fp2. Similarly to the spectrum illustrated in FIG. 4, the difference in absorbance between the maximum rising peak Mp and an intersection of the base line (obtained by connecting the first and second falling peaks Fp1 and Fp2) with a vertical line passing the maximum rising peak is defined as the height (R) of the maximum rising peak Mp.

The ratio (C/R) mentioned above is the ratio of the height (C) of the maximum rising peak Mp to the height (R) of the maximum rising peak Mp.

In the infrared absorption spectrum illustrated in FIG. 5, the first falling peak Fp1 is present at 784 cm⁻¹, the second falling peak Fp2 is present at 889 cm⁻¹, the base line ranges from 784 cm⁻¹ to 889 cm⁻¹, and the maximum rising peak Mp is present at 829 cm⁻¹.

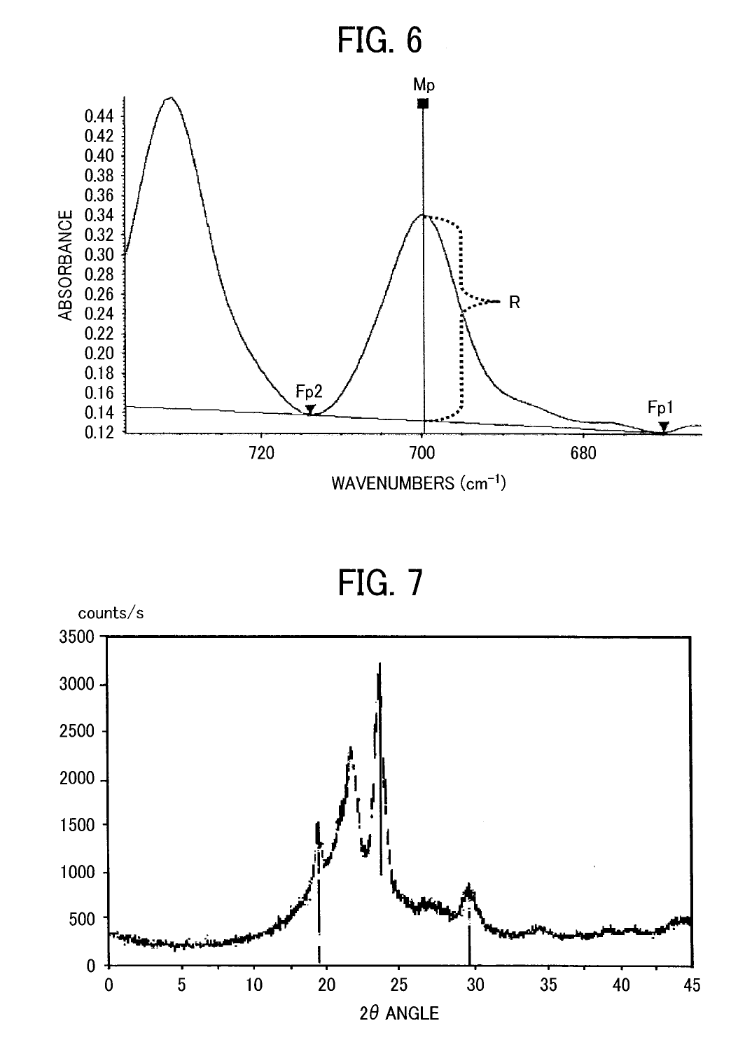

FIG. 6 illustrates the infrared absorption spectrum of a non-crystalline styrene-acrylic resin. As illustrated in FIG. 6, the infrared absorption spectrum of a non-crystalline styrene-acrylic resin is characterized in that a maximum rising peak Mp, a first falling peak Fp1, and a second falling peak Fp2 are present in a wavenumber range of from 660 cm⁻¹ to 720 cm⁻¹, and the maximum rising peak Mp is present between the first and second falling peaks Fp1 and Fp2. Similarly to the spectrum illustrated in FIG. 5, the difference in absorbance between the maximum rising peak Mp and an intersection of the base line (obtained by connecting the first and second falling peaks Fp1 and Fp2) with a vertical line passing the maximum rising peak is defined as the height (R) of the maximum rising peak Mp.

The ratio (C/R) mentioned above is the ratio of the height (C) of the maximum rising peak Mp to the height (R) of the maximum rising peak Mp.

In the infrared absorption spectrum illustrated in FIG. 6, the first falling peak Fp1 is present at 670 cm⁻¹, the second falling peak Fp2 is present at 714 cm⁻¹, the base line ranges from 670 cm⁻¹ to 714 cm⁻¹, and the maximum rising peak Mp is present at 699 cm⁻¹.

When a combination of the non-crystalline polyester resin and the non-crystalline styrene-acrylic resin is used as the non-crystalline resin (B), the height (R) of the maximum rising peak Mp in the range of from 780 cm⁻¹ to 900 cm⁻¹ and the height (R) of the maximum rising peak Mp in the range of from 660 cm⁻¹ to 720 cm⁻¹ are compared to select the greater height (R), and then the ratio (C/R) is determined using the greater height (R).

The content of the crystalline polyester resin (A) in the toner is preferably from 1 to 15 parts by weight, and more preferably from 1 to 10 parts by weight, based on 100 parts by weight of the non-crystalline resin (B). As mentioned later, the non-crystalline resin (B) preferably includes a non-crystalline resin (B-1) and another non-crystalline resin (B-2). In this case, the content of the non-crystalline resin (B-1) is preferably from 10 to 40 parts by weight, and the content of the non-crystalline resin (B-2) is preferably from 50 to 90 parts by weight, based on 100 parts by weight of the non-crystalline resin (B).

In this application, the gel permeation chromatography (GPC) used for determining the molecular weight distribution is the following.

1) The columns are stabilized at 40° C. in a heat chamber;
2) Tetrahydrofuran (THF) is fed to the columns at a flow rate of 1 ml/min;
3) a sample (resin) is dissolved in THF to prepare a THF solution of the resin having a solid content of from 0.05 to 0.6% by weight; and
4) 50 to 200 μl of the solution is fed to the columns to measure the weight average molecular weight (Mw) and the number average molecular weight (Mn) of the resin using a working curve showing relation between counts and amounts and prepared by using several monodisperse polystyrenes.

The monodisperse polystyrenes prepared by Pressure Chemical Co. or Tosoh Corp., and having different molecular weights, 6×10², 2.1×10³, 4×10³, 1.75×10⁴, 5.1×10⁴, 1.1×10⁵, 3.9×10⁵, 8.6×10⁵, 2×10⁶, and 4.48×10⁶, can be used for preparing the working curve. In measurements, a RI (refractive index) detector was used as the detector.

The non-crystalline resin (B) preferably includes a non-crystalline resin (B-1) and another non-crystalline resin (B-2), which has a softening point (T1/2) at least 25° C. lower than that of the non-crystalline resin (B-1). By using two kinds of non-crystalline resins (B-1) and (B-2), mixing of the crystalline polyester resin (A) with the non-crystalline resin (B) can be satisfactorily prevented because the content of the crystalline polyester resin (A) can be reduced. In addition, the non-crystalline resin (B-2) assists enhancement of the low temperature fixability by the crystalline polyester resin (A) without affecting enhancement of the hot offset resistance by the non-crystalline resin (B-1).

In this application, the softening point (T1/2) of a binder resin is measured with a flow tester, CFT-500 from Shimadzu Corporation, under the following conditions.

Volume of sample: 1 cm³

Diameter of hole of die: 1 mm

Pressure applied to sample: 20 kg/cm²

Temperature rising speed: 6° C./min

The softening point of the sample can be determined by the following equation.

T1/2=(T1+T2)/2,

wherein T1 represents the flow starting point (° C.) of the sample, and T2 represents the flow ending point (° C.) of the sample.

Any known crystalline polyester resins can be used for the crystalline polyester resin (A), but crystalline polyester resins having an ester bond having the following formula (1) in the main chain thereof are preferably used.

[—OCO—R—COO—(CH₂)ₙ—] (1)

wherein R represents an unsaturated linear hydrocarbon group having 2 to 20 carbon atoms, and n is an integer of from 2 to 20.

Whether or not a polyester resin has the ester bond having formula (1) can be determined by solid C¹³NMR.

Specific examples of the divalent residual group (—OCO—R—COO—) of an unsaturated linear carboxylic acid include divalent residual groups of maleic acid, fumaric acid, 1,3-n-propenedicarboxylic acid, and 1,4-n-butenedicarboxylic acid.

The group, —(CH₂)ₙ—, represents a residual group of a linear aliphatic dihydric alcohol. Specific examples of the residual group of a linear aliphatic dihydric alcohol include residual groups of ethylene glycol, 1,3-propylene glycol, 1,4-butanediol, and 1,6-hexanediol.

By using an unsaturated linear aliphatic dicarboxylic acid as an acid component of the crystalline polyester resin (A), the resultant crystalline polyester resin (A) can form a crystalline structure more easily than in a case of preparing a polyester resin by using an aromatic dicarboxylic acid as an acid component. In this case, the function of the crystalline polyester resin (A) can be effectively performed.

The crystalline polyester resin (A) can be prepared, for example, by subjecting (1) a polycarboxylic acid component including an unsaturated linear dicarboxylic acid or a derivative thereof (e.g., anhydrides, alkyl esters having 1 to 4 carbon atoms, and acid halides) and (2) a polyalcohol component including a linear aliphatic diol to a polycondensation reaction using a conventional method. In this regard, a small amount of a polyvalent carboxylic acid can be included in the polycarboxylic acid component, if desired.

Suitable materials for use as the polycarboxylic acids include (i) branched unsaturated aliphatic dicarboxylic acids, (ii) saturated aliphatic polycarboxylic acids such as saturated aliphatic dicarboxylic acids and saturated aliphatic tricarboxylic acids; and (iii) aromatic polycarboxylic acids such as aromatic dicarboxylic acids and aromatic tricarboxylic acids.

The added amount of such a polycarboxylic acid is not greater than 30% by mole, and preferably not greater than 10% by mole, based on the total of the carboxylic acid components so that the resultant polyester resin has crystallinity.

Specific examples of the optionally added polycarboxylic acid include dicarboxylic acids such as malonic acid, succinic acid, glutaric acid, adipic acid, suberic acid, sebacic acid, citraconic acid, phthalic acid, isophthalic acid, and terephthalic acid; and tri- or more-carboxylic acids such as trimellitic anhydride, 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylenecarboxypropane, and 1,2,7,8-octanetetracarboxylic acid.

The polyalcohol component can include a small amount of branched aliphatic dihydric alcohols, cyclic dihydric alcohols, and/or tri- or more-hydric alcohols. The added amount of such a polyalcohol is not greater than 30% by mole, and preferably not greater than 10% by mole, based on the total of the polyalcohol components so that the resultant polyester resin has crystallinity.

Specific examples of the optionally added polyalcohol include 1,4-bis(hydroxymethyl)cyclohexane, polyethylene glycol, ethylene oxide adducts of bisphenol A, propylene oxide adducts of bisphenol A, and glycerin.

The crystalline polyester resin (A) preferably has a relatively low molecular weight and a sharp molecular weight distribution to impart good low temperature fixability to the toner. Specifically, the weight average molecular weight (Mw) of such crystalline polyester resins is preferably from 5,500 to 6,500, the number average molecular weight (Mn) thereof is preferably from 1,300 to 1,500, and the ratio (Mw/Mn) is preferably from 2 to 5, when the molecular weights Mw and Mn are determined by the molecular weight distribution obtained by subjecting o-dichlorobenzene-soluble components of the crystalline polyester resin to gel permeation chromatography (GPC).

The molecular weight distribution of the crystalline polyester resin (A) is determined from a graph. Specifically, logarithmic molecular weights of components of the crystalline polyester resin are plotted on the horizontal axis, and weight percentages of the components are plotted on the vertical axis to prepare the molecular weight distribution curve of the crystalline polyester resin. In this case, it is preferable that the molecular weight peak is present in a weight percentage range of from 3.5% to 4.0% by weight, and the peak has a half width of not greater than 2.0, and more preferably not greater than 1.5.

The glass transition temperature (Tg) and the softening point (T1/2) of the crystalline polyester resin (A) are preferably as low as possible as long as the resultant toner has good high temperature preservability. The glass transition temperature (Tg) is generally from 80 to 130° C., and preferably from 80 to 125° C. The softening point (T1/2) is generally from 80 to 130° C., and preferably from 80 to 125° C. When the glass transition temperature (Tg) and the softening point (T1/2) are higher than the range, the minimum fixable temperature increases, and therefore the low temperature fixability of the toner deteriorates. In contrast, when the glass transition temperature (Tg) and the softening point (T1/2) are lower than the range, the high temperature preservability of the toner deteriorates.

Whether or not a crystalline polyester resin (A) has crystallinity can be determined by a powder X-ray diffractometer. Specifically, if a peak is observed in the X-ray diffraction spectrum of a polyester resin, the polyester resin has crystallinity.

It is preferable for the crystalline polyester resin (A) used for the toner of this disclosure to have an X-ray diffraction spectrum such that at least one diffraction peak is present in a 2θ angle range of from 19° to 25°, and it is more preferable that a diffraction peak is present in each of 2θ angle ranges of (i) from 19° to 20°, (ii) from 21° to 22°, (iii) from 23° to 25°, and (iv) from 29° to 31°. It is preferable that the toner has an X-ray diffraction peak in a 2θ angle range of from 19° to 25° because the crystalline polyester resin (A) maintains crystallinity in the toner, and thereby the function of the crystalline polyester resin (A) can be securely performed.

In this application, an instrument, RINT 1100 from RIGAKU CORPORATION, is used as the powder X-ray diffractometer. The measurement conditions are as follows.

Material used for tube: Cu

Tube voltage and current: 50 kV and 30 mA

Goniometer used: wide angle goniometer

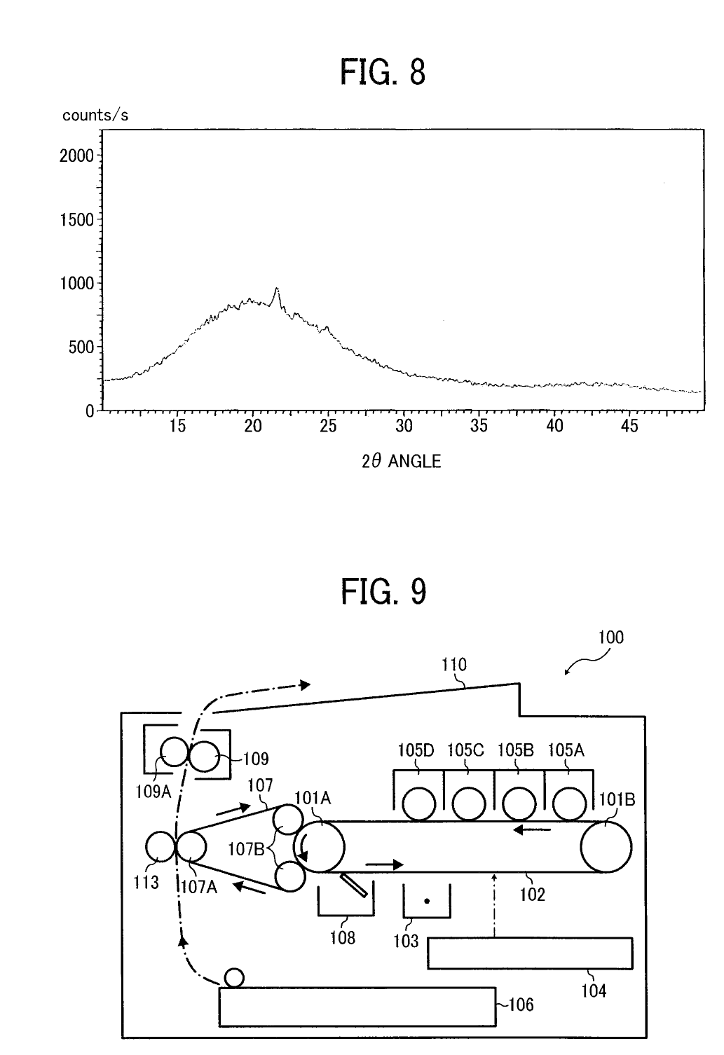

FIG. 7 illustrates the X-ray diffraction spectrum of the crystalline polyester resin a-6, which is used for Example 26 below and which will be described later in detail, and FIG. 8 illustrates the X-ray diffraction spectrum of the toner of Example 30.

It is preferable that the non-crystalline resin (B) includes a chloroform-insoluble component, and it is more preferable that the non-crystalline resin (B) includes a non-crystalline resin (B-1) and another non-crystalline resin (B-2), and the non-crystalline resin (B-1) includes a chloroform-insoluble component. In particular, it is preferable that the non-crystalline resin (B-1) includes a chloroform-insoluble component in an amount of from 5 to 40% by weight because good hot offset resistance can be imparted to toner. In this regard, it is preferable that the resultant toner includes a chloroform-insoluble component in an amount of from 1 to 30% by weight because good hot offset resistance can be imparted to the toner while the added amounts of the other resins such as the crystalline polyester resin (A) and the non-crystalline resin (B-2) can be controlled so as to fall in the preferable ranges mentioned above. If the amount of a chloroform-insoluble component in the toner is less than 1% by weight, good hot offset resistance is hardly imparted to the toner by the chloroform-insoluble component. In contrast, if the amount of a chloroform-insoluble component in the toner is greater than 30% by weight, the added amount of the resin used for enhancing good low temperature fixability to the toner is decreased, thereby deteriorating the low temperature fixability of the toner.

The content of a chloroform-insoluble component in a resin can be determined by the following method.

(1) about 1.0 g of a sample is precisely weighed;
(2) about 50 g of chloroform is added to the sample to dissolve the sample;
(3) after the solution is subjected to centrifugal separation, the liquid is filtered using a filter paper No. 5-C, which is described in JIS P3801 and which is weighed; and
(4) after the filter paper bearing chloroform-insoluble components thereon is dried, the filter paper is weighed to determine the weight of the insoluble components on the filter paper.

The content (C) of the chloroform-insoluble resin components in the sample is determined from the following equation.

C=(WI/WS)×100,

wherein WI represent the weight of the insoluble components on the filter paper, and WS represents the weight of the sample.

Toner typically includes a material insoluble in chloroform such as pigments other than resins. Therefore, when the content of the chloroform-insoluble components in such a toner is determined, the above-mentioned method is used and the content of such a material in the toner is previously determined by another method such as a thermal analysis. In this case, the content (CR) of the chloroform-insoluble resin components in the toner can be determined by the following equation.

CR=C−CM

wherein C represents the content of the chloroform-insoluble resin components and the chloroform-insoluble material in the toner determined by the above-mentioned method, and CM represents the content of the chloroform-insoluble material (other than the resins) in the toner determined by the other method such as a thermal analysis.

The non-crystalline resin (B-2) preferably has a softening point (T1/2) at least 25° C. lower than that of the non-crystalline resin (B-1) so that the resins (B-1) and (B-2) perform different functions Specifically, the non-crystalline resin (B-2) has a function of assisting the crystalline polyester resin (A) in imparting good low temperature fixability to the toner (i.e., a function of lowering the minimum fixable temperature of the toner), and the non-crystalline resin (B-1) has a function of imparting good hot offset resistance to the toner (i.e., a function of raising the maximum fixable temperature of the toner) due to the chloroform-insoluble component therein.

The non-crystalline resin (B-2) preferably has a molecular weight distribution, which is determined by subjecting THF-soluble components thereof to GPC, such that a main peak is observed in a range of from 1,000 to 10,000, and the half width of the main peak is not greater than 20,000, and preferably not greater than 15,000 and not less than 7,000. Such a non-crystalline resin (B-2) can impart good low temperature fixability to the toner, and therefore the resin can assist the crystalline polyester resin (A) in imparting good low temperature fixability to the toner even when the added amount of the crystalline polyester resin (A) is relatively small. When such a non-crystalline resin (B-2) is used, and the resultant toner has a GPC molecular weight distribution such that a main peak is observed in a range of from 1,000 to 10,000, and the half width of the main peak is not greater than 20,000, the content of the non-crystalline resin (B-2) in the toner is relatively high. As a result of the present inventors' investigation, it is found that when a crystalline polyester resin (A), a non-crystalline resin (B-1) and a non-crystalline resin (B-2) are used as the binder resin of toner in such a manner that the content of the non-crystalline resin (B-2) is relatively high compared to those of the other resins, a good combination of low temperature fixability, high temperature preservability and hot offset resistance can be imparted to the toner while balancing the properties without producing the adverse effects to be caused by excessive amounts of the crystalline polyester resin (A) and the THF-insoluble components of the resins.

Therefore, it is preferable that the toner of this disclosure has a molecular weight distribution, which is determined by subjecting THF-soluble components thereof to GPC, such that a main peak is observed in a range of from 1,000 to 10,000, and the half width of the main peak is not greater than 20,000. The half width of the main peak is more preferably not greater than 15,000 and not less than 7,000. When the half width of the main peak is less than 7,000, there is a case in which good low temperature fixability cannot be imparted to the toner.

It is preferable for the non-crystalline resins (B-1) and (B-2) that the non-crystalline resin (B-2) includes a chloroform-insoluble component, the non-crystalline resin (B-1) has a proper molecular weight distribution, and the non-crystalline resin (B-2) has a softening point (T1/2) at least 25° C. lower than that of the non-crystalline resin (B-1). Any known resins can be used for the non-crystalline resins (B-1) and (B-2) as long as the above-mentioned conditions are satisfied. For example, the below-mentioned resins can be used alone or in combination.

Specific examples of the resins for use as the non-crystalline resins (B-1) and (B-2) include homopolymers and copolymers of styrene such as polystyrene, polychlorostyrene, poly-α-methylstyrene, styrene-chlorostyrene copolymers, styrene-propylene copolymers, styrene-butadiene copolymers, styrene-vinyl chloride copolymers, styrene-vinyl acetate copolymers, styrene-maleic acid copolymers, styrene-acrylate copolymers (e.g., styrene-methyl acrylate copolymers, styrene-ethyl acrylate copolymers, styrene-butyl acrylate copolymers, styrene-octyl acrylate copolymers, and styrene-phenyl acrylate copolymers), styrene-methacrylate copolymers (e.g., styrene-methyl methacrylate copolymers, styrene-ethyl methacrylate copolymers, styrene-butyl methacrylate copolymers, and styrene-phenyl methacrylate copolymers), styrene-methyl α-chloroacrylate copolymers, and styrene-acrylonitrile-acrylate copolymers; and other resins such as vinyl chloride resins, rosin modified maleic acid resins, phenolic resins, epoxy resins, polyethylene resins, polypropylene resins, ionomer resins, polyurethane resins, silicone resins, ketone resins, ethylene-ethyl acrylate resins, xylene resins, polyvinyl butyral resins, petroleum resins, and hydrogenated petroleum resins.

The method for preparing these resins is not particularly limited, and any of bulk polymerization methods, solution polymerization methods, emulsion polymerization methods, and suspension polymerization methods can be used.

Non-crystalline polyester resins are preferably used as the non-crystalline resin (B) to impart good low temperature fixability to the toner. Specific examples of such non-crystalline polyester resins include polyester resins prepared by subjecting an alcohol and a carboxylic acid to condensation polymerization.

Specific examples of the alcohol include glycols such as ethylene glycol, diethylene glycol, triethylene glycol, and propylene glycol; 1,4-bis(hydroxymetha)cyclohexane; ethylated bisphenols such as ethylated bisphenol A; and other dihydric alcohols, and polyhydric alcohols having three or more hydroxyl groups.

Specific examples of the carboxylic acid include dibasic organic acids such as maleic acid, fumaric acid, phthalic acid, isophthalic acid, terephthalic acid, succinic acid, and malonic acid; and polycarboxylic aids having three or more carboxyl groups such as 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxy-2-methyl-2-methylenecarboxypropane, and 1,2,7,8-octanetetracarboxylic acid.

Among these polyester resins, polyester resins having a glass transition temperature (Tg) of not lower than 55° C., and preferably not lower than 60° C., are preferable because good high temperature preservability can be imparted to the toner.

A complex resin can be used as part or all of the non-crystalline resin (B). In this regard, the complex resin means a resin in which a condensation-polymerizable monomer and an addition-polymerizable monomer are chemically bonded and which includes a condensation-polymerized unit and an addition-polymerized unit, and is sometimes referred to as a hybrid resin.

The complex resin can be prepared by a method in which a mixture including a condensation-polymerizable monomer and an addition-polymerizable monomer is subjected to a condensation polymerization reaction and an addition polymerization reaction in a reaction vessel at the same time; or a method in which a condensation polymerization reaction and an addition polymerization reaction are serially performed, or vice versa.

Specific examples of the condensation-polymerizable monomer include a combination of a polyalcohol and a polycarboxylic acid, which is used for forming a polyester unit; a combination of a polycarboxylic acid and an amine or an amino acid, which is used for forming a polyamide unit or a polyester-polyamide unit.

Specific examples of dihydric alcohols for use as the polyalcohol include 1,2-propanediol, 1,3-propanediol, ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, and diols in which bisphenol A is polymerized with a cyclic ether such as ethylene oxide and propylene oxide.

Specific examples of tri- or more-hydric alcohols for use as the polyalcohol include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxybenzene.

Among these polyols, alcohols having a bisphenol A skeleton such as hydrogenated bisphenol A and diols in which bisphenol A is polymerized with a cyclic ether such as ethylene oxide and propylene oxide are preferable because a good combination of high temperature preservability and mechanical strength can be imparted to the resultant resin.

Specific examples of dibasic carboxylic acids for use as the polycarboxylic acid include benzene dicarboxylic acids such as phthalic acid, isophthalic acid, and terephthalic acid, and anhydrides thereof; alkyldicarboxylic acids such as succinic acid, adipic acid, sebacic acid, and azelaic acid, and anhydrides thereof; unsaturated dibasic acids such as maleic acid, citraconic acid, itaconic acid, alkenylsuccinic acid, fumaric acid, and mesaconic acid; and unsaturated diabasic anhydrides such as maleic anhydride, citraconic anhydride, itaconic anhydride, and alkenylsuccinic anhydride.

Specific examples of tribasic carboxylic acids for use as the polycarboxylic acid include trimellitic acid, pyromellitic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, tetra(methylenecarboxy)methane, 1,2,7,8-octanetetracarboxylic acid, EMPOL trimer acid, and anhydrides, and partial lower alkyl esters of these acids.

Among these acids, aromatic polycarboxylic acids such as phthalic acid, isophthalic acid, terephthalic acid, and trimellitic acid are preferable because a good combination of high temperature preservability and mechanical strength can be imparted to the resultant resin.

Specific examples of the amines used for forming a polyamide unit include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific examples of the diamines (B1) include aromatic diamines (e.g., phenylenediamine, diethyltoluenediamine, and 4,4′-diaminodiphenyl methane); alicyclic diamines (e.g., 4,4′-diamino-3,3′-dimethyldicyclohexyl methane, diaminocyclohexane and isophorondiamine); and aliphatic diamines (e.g., ethylenediamine, tetramethylenediamine and hexamethylenediamine).

Specific examples of the polyamines (B2) having three or more amino groups include diethylenetriamine, and triethylenetetramine.

Specific examples of the amino alcohols (B3) include ethanolamine, and hydroxyethylaniline.

Specific examples of the amino mercaptan (B4) include aminoethyl mercaptan and aminopropyl mercaptan.

Specific examples of the amino acids include amino propionic acid and amino caproic acid.

Specific examples of the blocked amines (B6) include ketimine compounds which are prepared by reacting one of the amines B1-B5 mentioned above with a ketone such as acetone, methyl ethyl ketone and methyl isobutyl ketone; and oxazolidine compounds.

The addition-polymerizable monomer for use in producing the above-mentioned complex resin is not particularly limited, and vinyl monomers are typically used therefor.

Specific examples of such vinyl monomers include styrene-based vinyl monomers such as styrene, o-methylstyrene, m-methylstyrene, p-methylstyrene, p-phenylstyrene, p-ethylstyrene, 2,4-dimethylstyrene, p-n-amylstyrene, p-tert-butylstyrene, p-n-hexylstyrene, p-n-4-dichlorostyrene, m-nitrostyrene, o-nitrostyrene, and p-nitrostyrene; acrylic monomers such as acrylic acid, methyl acrylate, ethyl acrylate, propyl acrylate, n-butyl acrylate, isobutyl acrylate, n-octyl acrylate, n-dodecyl acrylate, 2-ethylhexyl acrylate, steary acrylate, 2-chloroethyl acrylate, and phenyl acrylate; methacrylic monomers such as methacrylic acid, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, steary methacrylate, phenyl methacrylate, dimethylaminoethyl methacrylate, and diethylaminoethyl methacrylate; other vinyl monomers; and monomers for use in producing copolymers of vinyl monomers.

Specific examples of other vinyl monomers, and monomers for use in producing copolymers of vinyl monomers include monoolefins such as ethylene, propylene, butylene and isobutylene; polyenes such as butadiene and isoprene; halogenated vinyl monomers such as vinyl chloride, vinyl bromide and vinyl fluoride; vnyl esters such as vinyl acetate, vinyl propionate and vinyl benzoate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinyl pyrrole, n-vinyl carbazole, N-vinyl indole, and N-vinyl pyrrolidone; vinyl naphthalenes; acrylic or methacrylic acid derivatives such as acrylonitrile, methacrylonitrile and acrylamide; unsaturated dibasic acids such as maleic acid, citraconic acid, itaconic acid, alkenyl succinic acid, fumaric acid, and mesaconic acid; unsaturated dibasic acid anhydrides such as maleic anhydride, citraconic anhydride, itaconic anhydride, and alkenyl succinic anhydride; monoesters of unsaturated dibasic acids such as monomethyl ester of maleic acid, monoethyl ester of maleic acid, monobutyl ester of maleic acid, monomethyl ester of citraconic acid, monoethyl ester of citraconic acid, monobutyl ester of citraconic acid, monomethyl ester of itaconic acid, monomethyl ester of alkenyl succinic acid, monomethyl ester of fumaric acid, and monomethyl ester of mesaconic acid; esters of unsaturated dibasic acids such as dimethyl maleate and dimethyl fumarate; α,β-unsaturated acids such as crotonic acid and cinnamic acid; α,β-unsaturated acid anhydrides such as crotonic anhydride and cinnamic anhydride; monomers having a carboxyl group such as anhydrides of such an α,β-unsaturated acid and a lower fatty acid, alkenyl maloic acid, alkenyl glutaric acid, alkenyl adipic acid, and anhydrides, and esters thereof; hydroxyalkyl esters of acrylic or methacrylic acid such as 2-hydroxyethyl acrylate, and 2-hydroxyethyl methacrylate; and monomers having a hydroxyl group such as 4-(1-hydroxy-1-methylbutyl)styrene, and 4-(1-hydroxy-1-methylhexyl)styrene.

In order to form a condensation-polymerized unit chemically bonded with an addition-polymerized unit, a monomer (both-reactive monomer) which is condensation-polymerizable and addition-polymerizable is used. Specific examples thereof include unsaturated carboxylic acids such as acrylic acid and methacrylic acid; unsaturated dicarboxylic acids and anhydrides thereof such as fumaric acid, maleic acid, citraconic acid, itaconic acid, and anhydrides thereof; and vinyl monomers having a hydroxyl group.

The toner of this disclosure can optionally include a charge controlling agent. Specific examples thereof include derivatives of nigrosine and fatty acid metal salts, onium salts (such as phosphonium salts) and lake pigments thereof, triphenylmethane dyes and lake pigments thereof, and higher fatty acid metal salts; diorganotin oxides such as dibutyltin oxide, dioctyltin oxide and dicyclohexyltin oxide; diorganotin borates such as dibutyltin borate, dioctyltin borate and dicyclohexyltin borate; organic metal complexes, chelate compounds, monoazometal complexes, acetylacetone metal complexes, aromatic hydroxycarboxylic acids, metal salts of aromatic dicarboxylic acids, quaternary ammonium salts, salicylic acid metal salts, aromatic mono- or poly-carboxylic acids and metal salts, anhydrides and esters thereof, and phenol derivatives such as bisphenols. These can be used alone or in combination.

The added amount of such a charge controlling agent in the toner is from 0.1 to 10 parts by weight, and preferably from 1 to 5 parts by weight, based on 100 parts by weight of the resin components included in the toner.

Among these charge controlling agents, salicylic acid metal compounds are preferable because good hot offset resistance can also be imparted to the toner as well as charges. In particular, salicylic acid complexes including a tri- or more-valent metal capable of forming a six-coordinate structure can react with highly-reactive portions of a resin and a wax, thereby forming a crosslinked structure, resulting in enhancement of the hot offset resistance of the toner. In addition, when such a complex is used in combination with a complex resin, the dispersibility of the complex can be enhanced, and therefore the charge controlling function thereof can be enhanced.

Specific examples of the tri- or more-valent metal include Al, Fe, Cr and Zr.

Specific examples of the salicylic acid metal compound include compounds having the following formula.

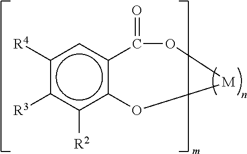

wherein each of R², R³ and R⁴ independently represents a hydrogen atom, a linear or branched alkyl group having 1 to 10 carbon atoms, or a linear or branched alkenyl group having 2 to 10 carbon atoms; M represents Cr, Zn, Ca, Zr or Al; m is an integer of not less than 2; and n is an integer of not less than 1.

Specific examples of marketed products of such salicylic acid metal complexes include BONTRON E-84 from Orient Chemical Industries Co., Ltd., which includes Zn as the metal.

The toner of this disclosure preferably has a DSC (differential scanning calorimetry) curve such that an endothermic peak specific to a crystalline polyester resin (A) is observed in a range of from 90 to 130° C. In this case, the crystalline polyester resin does not melt at normal temperature but melts at a relatively low fixing temperature. Therefore, the resultant toner can be easily fixed to a recording medium at a relatively low fixing temperature while having good high temperature preservability.

The endothermic energy amount of the endothermic peak is preferably not less than 1 J/g, and not greater than 15 J/g. When the endothermic energy amount is less than 1 J/g, the amount of the crystalline polyester resin effectively working in the toner is too small, and thereby the function of the crystalline polyester resin is hardly performed. When the endothermic energy amount is greater than 15 J/g, the amount of the crystalline polyester resin effectively working in the toner is too large, and thereby the glass transition temperature of the toner is decreased, resulting in deterioration of the high temperature preservability of the toner.

In this application, the DSC curve of toner is obtained by using a differential scanning calorimeter DSC-60 from Shimadzu Corporation. In this measurement, the sample (toner) is heated from 20° C. to 150° C. at a temperature rising speed of 10° C./min to obtain the DSC curve of the sample.

In this regard, an endothermic peak specific to a crystalline polyester resin is typically observed at a melting point of the resin, i.e., in a temperature range of from 80° C. to 130° C. The endothermic energy amount can be determined from the area of a portion surrounded by the endothermic peak and the base line of the peak. In general, in DSC, the temperature rising process (heating process) is performed twice, and the DSC curve is obtained from the second heating process. However, in this application, measurements concerning the endothermic peak and the glass transition temperature are performed based on the DSC curve obtained in the first heating process.

When the endothermic peak specific to a crystalline polyester resin (A) overlaps with an endothermic peak specific to a wax, the endothermic energy amount of the peak of the crystalline polyester resin (A) can be determined by subtracting the endothermic energy amount of the peak of the wax from the endothermic energy of the overlapped peak. The endothermic energy amount of the wax can be determined based on the endothermic energy amount of the wax itself and the content of the wax in the toner.

The toner of this disclosure preferably includes a fatty acid amide compound. When a fatty acid amide compound is used for a toner to be prepared by a method including a melting and kneading process, re-crystallization of a crystalline polyester resin (A), which is melted in the kneaded toner component mixture, can be accelerated by the fatty acid amide compound in a cooling process following the melting and kneading process. Therefore, mixing of the crystalline polyester resin (A) with the other resins can be prevented, thereby making it possible to prevent decrease in glass transition temperature of the toner, resulting in enhancement of the high temperature preservability of the toner. In addition, when a release agent is added to the toner, it becomes possible that the release agent is mainly present on the surface of a fixed toner image, and thereby good smear resistance can be imparted to the toner image (i.e., the rub resistance of the toner image can be enhanced).

The content of such a fatty acid amide compound in the toner is preferably from 0.5 to 10% by weight.

Among fatty acid amide compounds, compounds having the following formula are preferable.

R¹⁰—CO—NR¹²R¹³,

wherein R¹⁰ represents an aliphatic hydrocarbon group having 10 to 30 carbon atoms, and each of R¹² and R¹³ independently represents a hydrogen atom, an alkyl group having 1 to 10 carbon atoms, an aryl group having 6 to 10 carbon atoms, or an aralkyl group having 7 to 10 carbon atoms. The alkyl group, aryl group and aralkyl group of R¹² and R¹³ can optionally have an inert substituent such as fluorine atom, chlorine atom, cyano group, alkoxyl group, and alkylthio group. Preferably, an unsubstituted alkyl, aryl or aralkyl group is used for R¹² and R¹³.

Specific examples of suitable fatty acid amide compounds include stearic acid amide, stearic acid methyl amide, stearic acid diethyl amide, stearic acid benzyl amide, stearic acid phenyl amide, behenic acid amide, behenic acid dimethyl amide, myristic acid amide, and palmitic acid amide.

Among these fatty acid amide compounds, alkylenebis fatty acid amides having the following formula (II) are preferable.

R¹⁴—CO—NH—R¹⁵—NH—CO—R¹⁶ (II),

wherein each of R¹⁴ and R¹⁶ independently represents an alkyl or alkenyl group having 5 to 21 carbon atoms, and R¹⁵ represents an alkylene group having 1 to 20 carbon atoms.

Specific examples of the alkylenebis fatty acid amides having formula (II) include methylenebisstearic acid amide, ethylenebisstearic acid amide, methylenebispalmitic acid amide, ethylenebispalmitic acid amide, methylenebisbehenic acid amide, ethylenebisbehenic acid amide, hexamethylenebisstearic acid amide, hexaethylenebispalmitic acid amide, and hexamethylenebisbehenic acid amide. Among these, ethylenebisstearic acid amide is preferable.

The fatty acid amide compound used for the toner of this disclosure preferably has a softening point (T1/2) lower than the temperature of surface of the fixing member of the fixing device so that the fatty acid amide compound can serve as a release agent on the surface of the fixing member.

Specific examples of other alkylenebis fatty acid amide compounds for use in the toner of this disclosure include alkylenebis fatty acid amides of saturated fatty acids or unsaturated fatty acids having one or two double bonds such as propylenebisstearic acid amide, butylenbisstearic acid amide, methylenebisoleic acid amide, ethylenebisoleic acid amide, propylenebisoleic acid amide, butylenebisoleic acid amide, methylenebislauric acid amide, ethylenebislauric acid amide, propylenebislauric acid amide, butylenebislauric acid amide, methylenebismyristic acid amide, ethylenebismyristic acid amide, propylenebismyristic acid amide, butylenebismyristic acid amide, propylenebispalmitic acid amide, butylenebispalmitic acid amide, methylenebispalmitoleic acid amide, ethylenebispalmitoleic acid amide, propylenebispalmitoleic acid amide, butylenebispalmitoleic acid amide, methylenebisarachidic acid amide, ethylenebisarachidic acid amide, propylenebisarachidic acid amide, butylenebisarachidic acid amide, methylenebiseicosenoic acid amide, ethylenebiseicosenoic acid amide, propylenebiseicosenoic acid amide, butylenebiseicosenoic acid amide, methylenebisbehenic acid amide, ethylenebisbehenic acid amide, propylenebisbehenic acid amide, butylenebisbehenic acid amide, methylenebiserucic acid amide, ethylenebiserucic acid amide, propylenebiserucic acid amide, and butylenebiserucic acid amide.

Specific examples of the colorant for use in the toner of this disclosure include known pigments and dyes such as carbon black, lamp black, iron black, Aniline Blue, Phthalocyanine Blue, Phthalocyanine Green, HANSA YELLOW G, Rhodamine 6G Lake, chalco Oil Blue, chrome yellow, quinacridone, Benzidine Yellow, Rose Bengal and triaryl methane. These can be used alone or in combination. These colorants can be used for black toner and full color toners.

Particularly, carbon black has good tinting power. However, carbon black is a good electroconductive material, and therefore the electric resistance of the resultant toner decreases if the added amount of carbon black is large or the added carbon black aggregates in the toner, thereby often causing defective image transfer in an image transfer process. In particular, when carbon black is used in combination with a crystalline polyester resin (A), particles of the carbon black cannot enter into a domain of the crystalline polyester resin. Therefore, if the crystalline polyester resin (A) dispersed in the toner has a relatively large particle diameter, the carbon black is present in the resins other than the crystalline polyester resin at a relatively large concentration. In this case, the carbon black is present in the toner while aggregating, thereby excessively decreasing the electric resistance of the toner.

When carbon black is included in toner, the toner melted in a fixing process has a high viscosity. Therefore, even if the toner includes a non-crystalline resin (B-1) in a relatively large amount, occurrence of the hot offset problem, which is caused by decrease of viscosity of melted toner, can be prevented.

The added amount of such a colorant in the toner is generally from 1 to 30% by weight, and preferably from 3 to 20% by weight, based on the resin component included in the toner.

The toner of this disclosure can include a release agent. Specific examples thereof include synthesized waxes such as low molecular weight polyolefin waxes (e.g., low molecular weight polyethylene and low molecular weight polypropylene), and Fischer-Tropsch wax; natural waxes such as bees wax, carnauba wax, candelilla wax, rice wax, and montan wax; petroleum waxes such as paraffin wax, and microcrystalline wax; higher fatty acids such as stearic acid, palmitic acid, and myristic acid, and metal salts thereof; higher fatty acid amides, and synthesized ester waxes. Modified versions of these waxes can also be used.

Among these waxes, carnauba wax, modified carnauba wax, polyethylene wax, and synthesized ester waxes can be preferably used. Particularly, carnauba wax is more preferable because carnauba wax can be dispersed in a polyester resin or a polyol resin while having a small particle diameter, and therefore a good combination of hot offset resistance, transferability and durability can be imparted to the toner. In addition, when carnauba wax is used in combination with a fatty acid amide compound, the wax and the compound are mainly present on the surface of a fixed toner image, and therefore good smear resistance can be imparted to the toner image.

These release agents can be used alone or in combination. The added amount of such a release agent is preferably from 2 to 15% by weight based on the weight of the toner. If the added amount is less than 2% by weight, the hot offset preventing effect cannot be satisfactorily produced. When the added amount is greater than 15% by weight, transferability and durability of the toner tend to deteriorate.

Release agents having a melting point of from 70 to 150° C. are preferably used for the toner of this disclosure. When the melting point is lower than 70° C., the high temperature preservability of the toner tends to deteriorate. When the melting point is higher than 150° C., it is hard to impart good releasability to the toner.

The toner of this disclosure preferably has a volume average particle diameter of from 4 μm to 10 μm in order to produce high quality images with good fine line reproducibility. When the volume average particle diameter is less than 4 μm, cleanability and transferability of the toner tend to deteriorate, resulting in deterioration of image quality. When the volume average particle diameter is greater than 4 μm, fine line reproducibility of the toner tends to deteriorate.

Various methods can be used for measuring the volume average particle diameter of toner. In this application, COULTER COUNTER TAB from Beckman Coulter Inc. is used.

The toner of this disclosure is preferably prepared by a pulverization method including melting and kneading toner components to prepare a kneaded toner components, and pulverizing the kneaded toner components because the peak ratio (C/R) mentioned above can be well controlled.

The pulverization method typically includes mixing toner components including at least a crystalline polyester resin (A) and a non-crystalline resin (B), and optionally including other components such as a colorant, a release agent, a complex resin and a charge controlling agent; melting and kneading the toner component mixture; cooling the kneaded toner component mixture; and pulverizing the kneaded and cooled toner component mixture.

In the melting and kneading process, toner components are mixed and the mixture is fed into a kneader to melt and knead the toner components. Continuous single screw kneaders, continuous twin screw kneaders, and batch kneaders such as roll mills can be used as the kneader. Specific examples of the kneader include KTK twin screw extruders manufactured by Kobe Steel, Ltd., TEM twin screw extruders manufactured by Toshiba Machine Co., Ltd., twin screw extruders manufactured by KCK, PCM twin screw extruders manufactured by Ikegai Corp., and KO-KNEADER manufactured by Buss AG.

It is preferable that the melt kneading operation is performed while controlling the kneading temperature so that the molecular chain of the binder resin used is not cut. Specifically, when the kneading temperature is much higher than the softening point of the binder resin, the molecular chain is seriously cut. In contrast, when the kneading temperature is lower than the melting point, toner components cannot be well dispersed.

In the pulverization process, the kneaded toner component mixture is pulverized. In this regard, it is preferable that the kneaded toner component mixture is initially crushed, and then pulverized. In the pulverization process, a method in which crushed particles are collided to a plate using jet air; a method in which crushed particles are collided to each other using jet air; and a method in which crushed particles are pulverized at a narrow gap between a rotor and a stator are preferably used.

The pulverized toner component mixture is classified to prepare toner particles having a desired particle diameter. In this classification process, small particles are removed from the pulverized toner component mixture using a cyclone, a decanter, or a method using a centrifuge.

In addition, a classification operation in which the classified toner particles are further classified in an airstream using a centrifuge can be performed to prepare a toner having a desired particle diameter.

The toner of this disclosure is preferably a pulverization toner. However, if the kneaded toner component mixture is subjected to roll cooling in the cooling process such that the thickness of the cooled toner component mixture is not less than 2.5 mm, the kneaded toner component mixture is cooled at a slow cooling speed, and thereby the re-crystallization of the melted crystalline polyester resin (A) is performed over a relatively long period of time. Therefore, re-crystallization of the melted crystalline polyester resin (A) can be accelerated, and thereby function of the crystalline polyester resin (A) can be satisfactorily performed. Although acceleration of re-crystallization of the melted crystalline polyester resin (A) can be performed using a fatty acid amide as mentioned above, acceleration of re-crystallization can also be performed by using this cooling method. The upper limit of the thickness of the cooled toner component mixture is not particularly limited, but if the thickness is greater than 8 mm, the pulverization efficiency deteriorates, and the peak ratio (C/R) increases. Therefore, the thickness of the cooled toner component mixture is preferably not greater than 8 mm.

After the melting and kneading process, the kneaded toner component mixture is typically discharged from the kneader as a block. If the block of the toner component mixture is cooled, it takes time until the clock is cooled. Therefore, the kneaded toner component mixture is typically rolled to form a thin plate of the kneaded toner component mixture. As mentioned above, the thickness of the thin plate of the kneaded toner component mixture is preferably not less than 2.5 mm so that the kneaded toner component mixture is gradually cooled, thereby satisfactorily performing re-crystallization of the crystalline polyester resin (A).

The thus prepared toner particles can be mixed with a particulate inorganic material (external additive) such as hydrophobized particulate silica to enhance the fluidity, preservability, developing ability, and transferability of the toner.

When such an external additive is added to toner particles, known powder mixers are used. In this regard, the mixer is preferably equipped with a jacket so that the internal temperature of the mixer can be controlled. In order to change history of load applied to the external additive, a method in which the external additive is added in the middle of the mixing process, or a method in which the external additive is gradually added can be used.

In addition, in order to change history of load applied to the external additive, it is possible to change conditions of the mixer such as number of rotations, rolling speed, mixing time and mixing temperature. In addition, a method in which a high load is applied initially, and then a relatively low load is applied, or vice versa can also be used.

Specific examples of the mixer include V-shaped mixers, rocking mixers, LOEDGE MIXER, NAUTER MIXER, and HENSCHEL MIXER.

After the external additive addition process, the mixture may be filtered using a screen with 250- or more-mesh to remove coarse particles or aggregated particles.

The toner of this disclosure can be used as a one-component developer. In addition, the toner may be mixed with a carrier to be used as a two-component developer. When the toner is used for high speed image forming apparatuses such as high speed printers capable of performing high speed information processing, the toner is preferably used as a two-component developer to prolong the life of the developer.

An example (full color image forming apparatus) of the electrophotographic image forming apparatus of this disclosure is illustrated in FIG. 9. The image forming method of this disclosure can be performed by using such an image forming apparatus (i.e., an image forming apparatus using a developing device).

Referring to FIG. 9, numeral 100 denotes an image forming apparatus of this disclosure. Numerals 101A and 101B respectively denote a driving roller, and a driven roller. Numerals 102, 103 and 104 respectively denote a photoreceptor belt serving as an image bearing member, a charger and a laser writing unit serving as an irradiator. Numerals 105A to 105D respectively denote a yellow developing unit (developing device) containing a yellow toner, a magenta developing unit containing a magenta toner, a cyan developing unit containing a cyan toner, and a black developing unit containing a black toner. Numeral 106 denotes a recording medium cassette. Numerals 107, 107A and 107B respectively denote an intermediate transfer belt, a driving roller to drive the intermediate transfer belt, and driven rollers to support the intermediate transfer belt. The combination of the intermediate transfer belt 107, the driving roller 107A, and the driven rollers 107B serve as an intermediate transferring device. Numeral 108 denotes a cleaner, and numerals 109 and 109A respectively denote a fixing roller and a pressure roller. The combination of the fixing roller 109 and the pressure roller 109A serve as a fixing device. Numeral 110 denotes a copy tray, and numeral 113 denotes a transfer roller serving as a secondary transferring device.

In the full color image forming apparatus 100 illustrated in FIG. 9, a flexible intermediate transfer belt 107 serving as an intermediate transfer medium is used. The intermediate transfer belt 107 is rotated clockwise while tightly stretched by the driving roller 107A and the driven rollers 107B. The portion of the intermediate transfer belt 107 located between the pair of driven rollers 107B is contacted with the outer surface of a portion of the photoreceptor belt 102 located on a surface of the driving roller 101A.

When a full color image is formed in the color image forming apparatus, yellow, magenta, cyan and black toner images formed on the photoreceptor belt 102 by the developing units 105A-105D are sequentially transferred onto the intermediate transfer belt 107 so as to be overlaid, thereby forming a combined color toner image on the intermediate transfer belt 107. The combined color toner image is transferred onto a recording medium sheet, which is fed from the recording material sheet cassette 106, by the transfer roller 113. The recording medium sheet bearing the combined color toner image thereon is fed to a fixing nip between the fixing roller 109 and the pressure roller 109A so that the toner image is fixed to the recording medium sheet by the rollers 109 and 109A. The recording medium sheet bearing the fixed toner image thereon (i.e., copy) is discharged so as to be stacked on the copy tray 110.

After the developing units 105A-105E perform the developing operations using the respective developers contained therein, the concentrations of color toners contained in the developers decrease. In this regard, the concentration of the toner in a developer is detected by a toner concentration sensor. When decrease of the toner concentration is detected by the toner concentration sensor, a developer supplying device connected with the developing unit 105 is operated to supply the toner to the developing device 105, thereby increasing the toner concentration of the developer. In this regard, the developing unit may use a trickle developing method, i.e., the developing unit may be equipped with a developer discharging mechanism to discharge part of the developer from the developing unit while supplying a mixture of the toner and the carrier to the developing unit instead of supply of only the toner.

In the image forming apparatus illustrated in FIG. 9, color toner images formed on the photoreceptor belt 102 are overlaid on the intermediate transfer belt 107. However, the image forming apparatus of this disclosure is not limited thereto. For example, a direct-transfer type image forming apparatus in which color toner images formed on one or more photoreceptors are directly transferred onto a recording medium can also be used as the image forming apparatus of this disclosure.

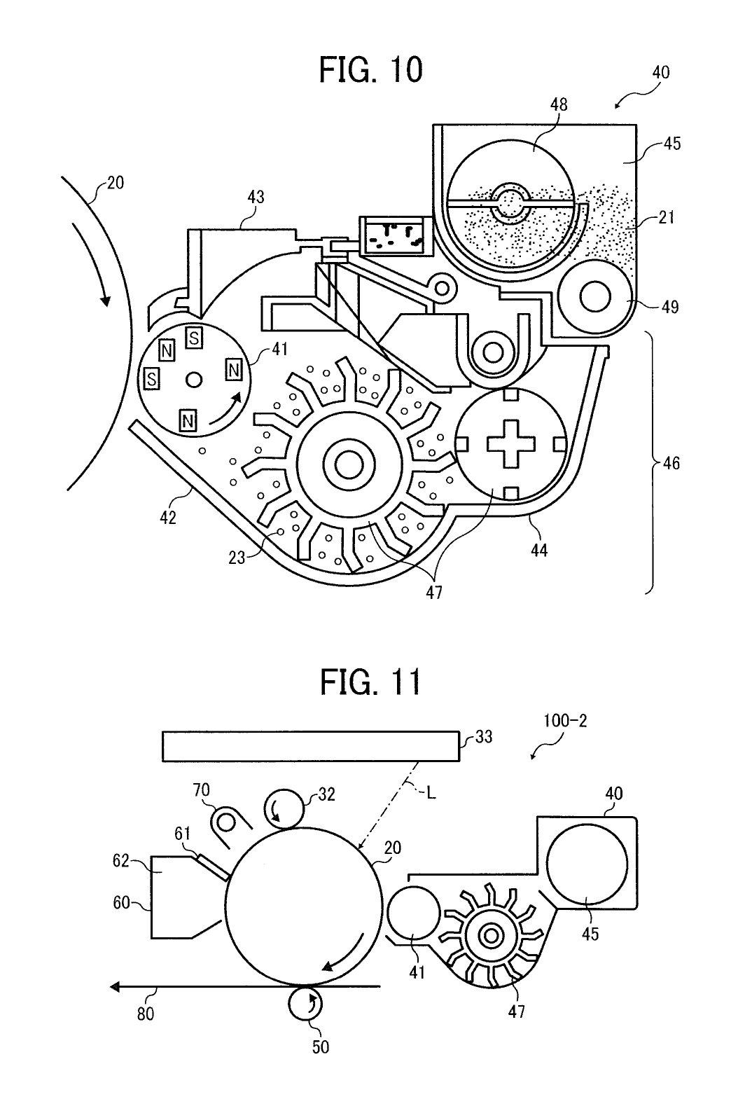

FIG. 10 is a schematic view illustrating a developing device for use as the developing unit of the image forming apparatus of this disclosure. The developing device is not limited thereto, and modifications such as the below-mentioned modifications can be made thereto.

Referring to FIG. 10, a developing device 40 is arranged so as to be opposed to a photoreceptor 20 serving as an image bearing member. The developing device 40 includes, as main components, a developing sleeve 41, a developer containing portion 46 including a developer container 42 and a support case 44, and a doctor blade 43 serving as a regulating member.

A toner hopper 45 serving as a toner container is connected with the support case 44, which has an opening on the photoreceptor side thereof. The developer containing portion 46, which is located in the vicinity of the toner hopper 45, contains the developer including a toner 21, which is the toner of this disclosure, and a carrier 23, and has developer agitators 47 to agitate the developer to impart frictional/separating charges to particles of the toner 21.

In the toner hopper 45, a toner agitator 48 and a toner supplying member 49, which are rotated by a driving device, are arranged. The toner agitator 48 and the toner supplying member 49 supply the toner 21 in the toner hopper 45 to the developer containing portion 46 while agitating the toner.

The developing sleeve 41, which is arranged so as to be opposed to the photoreceptor 20, is rotated by a driving device (not shown) in a direction indicated by an arrow. The developing sleeve 41 has magnets therein to form magnetic brush (i.e., chains of carrier particles (developer)) thereon. The magnets serve as a magnetic field forming member, and are fixedly arranged inside the developing sleeve 41.

The doctor blade 43 serving as a regulating member is integrally provided on one side of the developer container 42. In this example, the doctor blade 43 is arranged such that a predetermined gap is formed between the tip of the doctor blade and the circumferential surface of the developing sleeve 41.

A developing method using the developing device will be described. Specifically, the toner 21 is fed from the toner hopper 45 to the developer containing portion 46 by the toner agitator 48 and toner supplying member 49, and the toner 21 and the carrier 23 (i.e., the developer) are agitated by the developer agitators 47, resulting in impartment of frictional/separating charge to the toner. The developer is born on the surface of the developing sleeve 41, and then fed to the development region, in which the developing sleeve is opposed to the photoreceptor 20. In the development region, only the toner 21 is adhered to an electrostatic latent image formed on the photoreceptor 20, and thereby a toner image is formed on the surface of the photoreceptor 20.

FIG. 11 is a cross-sectional view of an example of the image forming apparatus of this disclosure, which includes the developing device mentioned above by reference to FIG. 10. Referring to FIG. 11, an image forming apparatus 100-2 includes a charger 32 to charge a drum-shaped photoreceptor 20 serving as the image bearing member; an irradiator 33 to irradiate the charged photoreceptor with light L to form an electrostatic latent image on the photoreceptor 20; the developing device 40 to develop the electrostatic latent image with a developer including the toner of this disclosure to form a toner image on the photoreceptor; a transferring device 50 to transfer the toner image onto a recording medium 80; a cleaner 60 to clean the surface of the photoreceptor 20, which includes a cleaning blade 61 and a collected toner container 62; and a discharging lamp 70 to reduce the residual charges present on the photoreceptor 20. These devices are arranged around the photoreceptor 20. In this image forming apparatus, the charger 32 and the irradiator 33 serve as an electrostatic latent image forming device.

In this image forming apparatus 100-2, the charger 32 is a short-range charger, and the gap between the surface of the photoreceptor 20 and the surface of the charging roller of the charger 32 is about 0.2 mm. In this regard, it is preferable that a DC voltage on which an AC voltage is superimposed is applied to the charging device 32 by a voltage applicator so that the photoreceptor 20 can be evenly charged by the charger. The image forming method and the developing method of the image forming apparatus are the following.

In this example of the image forming method, a nega-posi image forming operation is performed. Specifically, after charges remaining on the photoreceptor 20, which serves as the image bearing member and which is typified by an organic photoreceptor (OPC) having an organic photosensitive layer, are discharged by the discharging lamp 70 (i.e., discharging process), the surface of the photoreceptor 20 is negatively charged by the charger 32 such as charging rollers and charging wires (i.e., charging process). Next, laser light emitted by the irradiator 33 irradiates the charged photoreceptor 20 to form an electrostatic latent image thereon (i.e., electrostatic latent image forming process or irradiating process). In this regard, the absolute value of the potential of an irradiated portion of the photoreceptor 20 is lower than that of a non-irradiated portion of the photoreceptor.

Laser light emitted by a laser diode of the irradiator 33 is reflected by a polygon mirror, which is rotated at a high speed, to scan the surface of the photoreceptor 20 in a direction (i.e., main scanning direction) parallel to the rotation axis of the photoreceptor, resulting in formation of an electrostatic latent image on the photoreceptor. The thus formed electrostatic latent image is developed with the developer (including the toner and a carrier) on the developing sleeve 41, resulting in formation of a toner image on the photoreceptor 20. In this developing process, a proper DC voltage, on which an AC voltage is optionally superimposed and whose voltage falls between the potential of the irradiated portion of the photoreceptor 20 and the potential of the non-irradiated portion thereof, is applied as a development bias to the developing sleeve 41 by a voltage applicator.

Meanwhile, the recording medium 80 such as paper sheets is fed by a feeding device (such as the recording medium sheet cassette 106 illustrated in FIG. 9). The thus fed recording material 80 is timely fed by a pair of registration rollers to a transfer nip formed between the photoreceptor 20 and the transferring device 50 so that the toner image on the photoreceptor 20 is transferred onto a proper position of the recording medium 80 in the transfer region. In this regard, it is preferable that a voltage having a polarity opposite to that of the charge of the toner 21 is applied as a transfer bias to the transferring device 50. The recording medium 80 bearing the toner image thereon is then separated from the photoreceptor 20. Thus, a toner image is formed on the recording medium 80.

Residual toner particles remaining on the photoreceptor 20 even after the transfer process are removed therefrom by the cleaning blade 61 of the cleaner 60 (i.e., cleaning process).

The thus collected toner particles are stored in the collected toner container 62. The collected toner particles may be fed by a toner recycling device to the developing device or the toner hopper 45 to be reused.

The recording medium 80 bearing the toner image thereon is then fed to a fixing device (such as the heat fixing device 109 and 109A illustrated in FIG. 9) to fix the toner image on the recording medium. In this regard, as mentioned above by reference to FIG. 9, the image forming apparatus illustrated in FIG. 11 can have multiple developing devices so that multiple color toner images are sequentially formed on the photoreceptor 20, and the toner images are sequentially transferred onto the recording medium 80 optionally via an intermediate transfer medium to form a combined color toner image on the recording medium 80. The combined color toner image is then fixed by a fixing device.

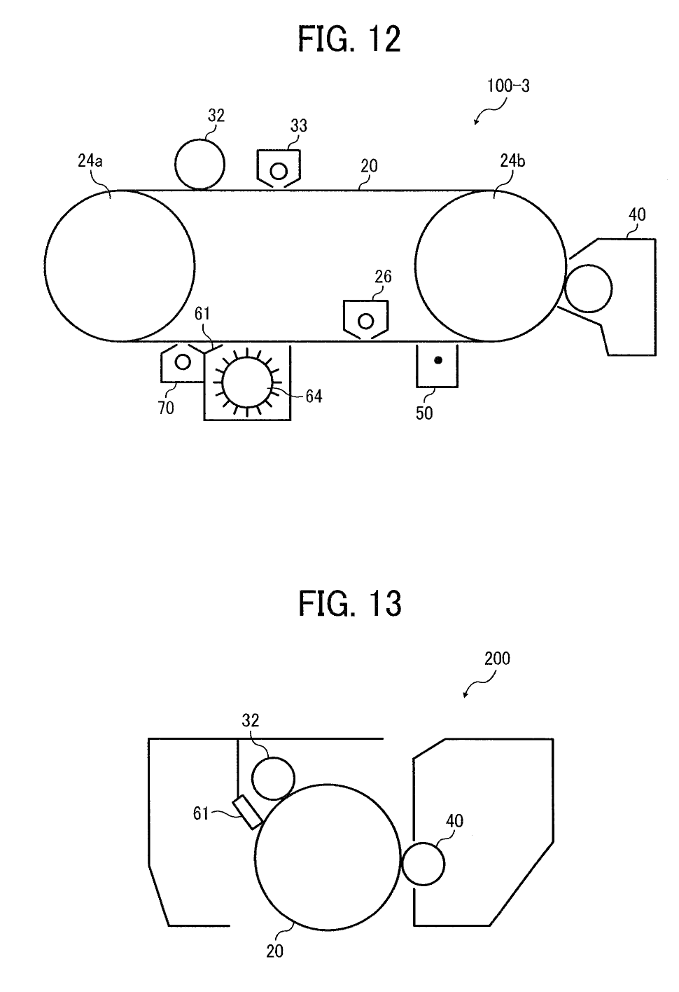

FIG. 12 illustrates another example of the image forming apparatus of this disclosure. In an image forming apparatus 100-3, the photoreceptor 20 is an endless-belt-shaped photoreceptor having configuration such that at least a photosensitive layer is formed on an electroconductive substrate. The photoreceptor belt 20 is driven so as to be rotated by driving rollers 24a and 24b. Similarly to the image forming apparatus 100-2 illustrated in FIG. 11, the photoreceptor belt 20 is charged by the charger 32, and then exposed to light emitted by the irradiator 33, resulting in formation of an electrostatic latent image on the photoreceptor belt 20. The electrostatic latent image is developed by the developing device 40 to form a toner image on the photoreceptor belt 20, and the toner image is transferred onto a recording medium by a charger 50 serving as a transferring device. The photoreceptor belt 20 is then subjected to a pre-cleaning irradiating process using a light source 26; a cleaning process using a cleaner including the cleaning blade 61 and a cleaning brush 64; and a discharging process using the discharging lamp 70. In the image forming apparatus illustrated in FIG. 12, the pre-cleaning irradiation process is performed from the backside (i.e., substrate side) of the photoreceptor belt 20. In this regard, the substrate of the photoreceptor belt 20 is transparent so that light used for the pre-cleaning light irradiation process reaches the photosensitive layer of the photoreceptor belt 20.

FIG. 13 illustrates an example of the process cartridge of this disclosure. Referring to FIG. 13, a process cartridge 200 uses the developer including the toner of this disclosure, and includes the photoreceptor 20 serving as an image bearing member, a brush-form contact charger 32 to charge the photoreceptor, the developing device 40 to develop an electrostatic latent image formed on the photoreceptor 20 using a developer including the toner of this disclosure, and the cleaning blade 61 serving as a cleaner to clean the surface of the photoreceptor. The photoreceptor 20, the charger 32, the developing device 40 and the cleaning blade 61 are integrated as a unit so that the process cartridge can be detachably attached to an image forming apparatus.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis of Crystalline Polyester Resins a-1 to a-7

Crystalline polyester resins a-1 to a-7 were prepared using an alcohol component (1,5-pentanediol), and a carboxylic acid component selected from fumaric acid, maleic acid and terephthalic acid.

Specifically, after the alcohol component and the carboxylic acid component described in Table 1 were subjected to an esterification reaction using no catalyst at a temperature of from 170 to 260° C. under normal pressure, antimony trioxide was added to the reaction product in an amount of 400 ppm based on the carboxylic acid component to perform a polycondensation reaction at 250° C. under vacuum of 3 Torr (400 Pa) while discharging the glycol from the reaction system. Thus, crystalline polyester resins a-1 to a-7 were prepared. In this regard, the polycondensation reaction was performed until the reaction product had an agitation torque of 10 kg·cm (at 100 rpm), and the reaction was stopped by stopping decompression.

The formula and the properties of the crystalline polyester resins a-1 to a-7 are shown in Table 1 below.

TABLE 1

| | Glass | | | Presence or | | |
|---|---|---|---|---|---|---|
| | transition | Softening | DSC peak | absence of | | |
| Crystalline | temperature | point T½ | temperature | ester bond of | Alcohol | Carboxylic acid |
| polyester | Tg (° C.) | (° C.) | (° C.) | formula (1) | component | component |
| a-1 | 98 | 104 | 108 | Absent | 1,5- | Fumaric acid |
| | | | | | pentanediol | |
| a-2 | 81 | 86 | 89 | Absent | 1,5- | Terephthalic |
| | | | | | pentanediol | acid |
| a-3 | 84 | 89 | 92 | Absent | 1,5- | Maleic acid |
| | | | | | pentanediol | |
| a-4 | 116 | 122 | 127 | Absent | 1,5- | Terephthalic |
| | | | | | pentanediol | acid |
| a-5 | 119 | 126 | 131 | Absent | 1,5- | Terephthalic |
| | | | | | pentanediol | acid |
| a-6 | 100 | 106 | 110 | present | 1,5- | Fumaric |
| | | | | | pentanediol | acid |
| a-7 | 128 | 135 | 128 | Absent | 1,5- | Terephthalic |
| | | | | | pentanediol | acid |

It was confirmed that since each of the polyester resins a-1 to a-7 has an X-ray diffraction spectrum obtained by a powder X-ray diffractometer such that at least one peak is present in a 2θ angle of from 19° to 25°, the polyester resins a-1 to a-7 are crystalline polyester resins. The X-ray diffraction spectrum of the crystalline polyester resin a-6 is illustrated in FIG. 7.

Synthesis of Non-Crystalline Resins b1-1 to b1-3 and b2-1 to b2-8

Non-crystalline resins b1-1 to b1-3 and b2-1 to b2-8 were prepared using alcohol components, and carboxylic acid components described in Table 2.

Specifically, after the alcohol components and the carboxylic acid components described in Table 2 were subjected to an esterification reaction using no catalyst at a temperature of from 170 to 260° C. under normal pressure, antimony trioxide was added to the reaction product in an amount of 400 ppm based on the carboxylic acid components to perform a polycondensation reaction at 250° C. under vacuum of 3 Torr (400 Pa) while discharging the glycols from the reaction system. Thus, non-crystalline polyester resins b1-1 to b1-3 and b2-1 to b2-8 were prepared. In this regard, the polycondensation reaction was performed until the reaction product had an agitation torque of 10 kg·cm (at 100 rpm), and the reaction was stopped by stopping decompression.

The formula and the properties of the non-crystalline polyester resins b1-1 to b1-3 and b2-1 to b2-8 are shown in Table 2 below.

TABLE 2

| | | Content of | | |
|---|---|---|---|---|
| | | chloroform- | | |
| Non- | Softening | insoluble | | Carboxylic |
| crystalline | point T½ | component | Alcohol | acid |
| resin B-1 | (° C.) | (% by weight) | component | component |
| Polyester | 140 | 21 | BPA(2.2)PO, | Fumaric acid, |
| resin | | | BPA(2.2)EO | Trimellitic |
| b1-1 | | | | anhydride |
| Polyester | 140 | 6 | BPA(2.2)PO, | Fumaric acid, |
| resin | | | BPA(2.2)EO | Trimellitic |
| b1-2 | | | | anhydride |
| Polyester | 151 | 39 | BPA(2.2)PO, | Dodecenyl |
| resin | | | BPA(2.2)EO | succinic |
| b1-3 | | | | anhydride, |
| | | | | Trimellitic |
| | | | | anhydride |

BPA(2.2)PO: Propylene oxide (2.2) adduct of Bisphenol A
BPA(2.2)EO: Ethylene oxide (2.2) adduct of Bisphenol A

TABLE 3

| | | Glass | Main peak | Half | | |
|---|---|---|---|---|---|---|
| Non- | Softening | transition | in molecular | width of | | Carboxylic |
| crystalline | point T½ | temperature | weight | main | Alcohol | acid |
| resin B-2 | (° C.) | (° C.) | distribution | peak | component | component |
| Polyester | 105 | 63 | 7,000 | 22,000 | BPA(2.2)PO, | Terephthalic |
| resin b2-1 | | | | | BPA(2.2)EO | acid, |
| | | | | | | Trimellitic |
| | | | | | | anhydride |
| Polyester | 89 | 62 | 4,000 | 13,000 | BPA(2.2)PO, | Terephthalic |
| resin b2-2 | | | | | BPA(2.2)EO | acid, |
| | | | | | | Trimellitic |
| | | | | | | anhydride |
| Polyester | 135 | 60 | 14,000 | 31,000 | BPA(2.2)PO, | Terephthalic |
| resin b2-3 | | | | | BPA(2.2)EO | acid, |
| | | | | | | Trimellitic |
| | | | | | | anhydride |
| Polyester | 100 | 63 | 7,000 | 17,000 | BPA(2.2)PO, | Terephthalic |
| resin b2-4 | | | | | BPA(2.2)EO | acid, |
| | | | | | | Trimellitic |
| | | | | | | anhydride |
| Polyester | 110 | 85 | 8,000 | 18,000 | BPA(2.2)PO, | Terephthalic |
| resin b2-5 | | | | | BPA(2.2)EO | acid, |
| | | | | | | Trimellitic |
| | | | | | | anhydride |
| Polyester | 112 | 92 | 9,000 | 21,000 | BPA(2.2)PO, | Terephthalic |
| resin b2-6 | | | | | BPA(2.2)EO | acid, |
| | | | | | | Trimellitic |
| | | | | | | anhydride |
| Polyester | 98 | 55 | 6,500 | 17,000 | BPA(2.2)PO, | Terephthalic |
| resin b2-7 | | | | | BPA(2.2)EO | acid, |
| | | | | | | Trimellitic |
| | | | | | | anhydride |
| Polyester | 88 | 60 | 3,500 | 10,000 | BPA(2.2)PO, | Terephthalic |
| resin b2-8 | | | | | BPA(2.2)EO | acid, |
| | | | | | | Trimellitic |
| | | | | | | anhydride |

It was confirmed that each of the polyester resins b1-1 to b1-3 and b2-1 to b2-8 has an X-ray diffraction spectrum having no peak, and therefore the polyester resins are non-crystalline resins.

In addition, it was confirmed that each of the polyester resins b2-1 to b2-8 can be perfectly dissolved in chloroform, and therefore the resins include no chloroform-insoluble component.

### Synthesis of Complex Resin c-1

Styrene, acrylic acid, and 2-ethylhexyl acrylate were used as addition-polymerizable monomers, dicumyl peroxide was used as a polymerization initiator, and terephthalic acid, trimellitic anhydride, propylene oxide (2.2) adduct of bisphenol A, and ethylene oxide (2.2) adduct of bisphenol A were used as condensation-polymerizable monomers.

While the condensation-polymerizable monomers and dibutyltin oxide serving as an esterification catalyst were agitated at 160° C. under a nitrogen gas flow and normal pressure, a mixture of the addition-polymerizable monomers and the polymerization initiator was dropped from a dropping funnel over one hour. Thereafter, the mixture was heated at 160° C. for 2 hours to perform addition polymerization. Next, the reaction product was heated at a temperature of from 170 to 260° C. to perform an esterification reaction, and then antimony trioxide was added to the reaction product in an amount of 400 ppm based on the carboxylic acid components to perform a polycondensation reaction at 250° C. under vacuum of 3 Torr (400 Pa) while discharging the glycols from the reaction system. Thus, a complex resin c-1 was prepared. In this regard, the polycondensation reaction was performed until the reaction product had an agitation torque of 10 kg·cm (at 100 rpm), and the reaction was stopped by stopping decompression.

The formula and the properties of the complex resin c-1 are shown in Table 4 below.

TABLE 4

| | Condensation- | Addition- | Softening | Glass transition | |
|---|---|---|---|---|---|
| Complex | polymerized | polymerized | point T½ | temperature | Acid value |
| resin | unit | unit | (° C.) | Tg (° C.) | (mgKOH/g) |
| c-1 | Polyester unit | Vinyl unit | 115 | 58 | 25 |

### Colorant

As described in Table 5 below, carbon black and Phthalocyanine Blue were used as the colorants of the toners of the below-mentioned examples and comparative examples.

TABLE 5

| Colorant | Material |
|---|---|
| p-1 | Carbon black |
| p-2 | Phthalocyanine Blue |

### Example 1

### Preparation of Pulverized Toner 1

The following components were mixed using a HENSCHEL MIXER mixer, FB-20B from Mitsui Miike Machinery Co., Ltd.

| | | |
|---|---|---|
| Crystalline polyester resin a-1 | 4 | parts |
| Non-crystalline resin b1-1 | 35 | parts |
| Non-crystalline resin b2-1 | 65 | parts |
| Colorant p-1 | 14 | parts |
| Carnauba wax serving as release agent | 6 | parts |
| (melting point of 81° C.) | | |
| Monoazo metal complex serving as charge controlling agent | 2 | parts |
| (Chromic complex dye, BONTRON S-34 from Orient | | |
| Chemical Industries Co., Ltd.) | | |

The mixture was melted and kneaded by a twin screw extruder PCM-30 from Ikegai Corporation under conditions such that the temperature of the kneading portion is 120° C. and the temperature of the feeding portion is 100° C.

After the kneaded mixture was rolled so as to have a thickness of 2.7 mm, the rolled mixture was cooled to room temperature using a belt cooler. The cooled mixture was crushed by a hammer mill so as to have a particle diameter of from 200 μm to 300 μm. Next, the crushed mixture was pulverized using a jet pulverizer LABOJET from Nippon Pneumatic Mfg. Co., Ltd., and the pulverized mixture was classified using an air classifier MDS-1 from Nippon Pneumatic Mfg. Co., Ltd. while adjusting the louver opening so that the resultant particles have a volume average particle diameter of 7.0±0.2 μm. Thus, toner particles were prepared.

Next, 100 parts of the toner particles were mixed with 1.0 part of an external additive HDK-H2000 (pyrogenic silica) from Wacker Chemie AG, and the mixture was mixed using a HENSCHEL MIXER mixer. Thus, a pulverization toner 1 was prepared.

Next, 5 parts of the pulverization toner 1 and 95 parts of a coated ferrite carrier were mixed for 5 minutes using a TURBULA MIXER mixer from Willy A. Backofen AG at a revolution of 48 rpm. Thus, a developer 1 was prepared.

### Examples 2-31 and Comparative Examples 1-15

The procedure for preparation of the developer 1 was repeated except that the formulation of the toner, and the kneading condition and the cooling condition of the toner were changed as described in Table 6 below.

Thus, toners 2-31 and developers 2-31 of Examples 2-31 and toners 32-46 and developers 32-46 of Comparative Examples 1-15 were prepared.

In Example 25 (toner 25), the colorant p-2, Phthalocyanine Blue (copper Phthalocyanine pigment), was used. In this case, 50 parts of the colorant p-2, 100 parts of the non-crystalline resin b2-1 and 50 parts of water were subjected to a preliminary kneading treatment to prepare a master batch, and the master batch was used for preparing the toner 25. In this application, the method for preparing a master batch is not limited thereto.

In Example 29, a metal complex (zinc salicylate compound), BONTRON E-84 from Orient Chemical Industries Co., Ltd. was used as the charge controlling agent.

The formula and property of the toners 1-46 and the kneading and cooling conditions therefor are shown in Tables 6-1 and 6-2 below.

TABLE 6-1

| | | Crystalline | | Non-crystalline | | Non-crystalline | | | |
|---|---|---|---|---|---|---|---|---|---|
| | | resin (A) | | resin (B-1) | | resin (B-2) | | | |
| | | | Added | | Added | | Added | | Fatty |
| | | | amount | | amount | | amount | Complex | acid |
| | Toner | Resin | (parts) | Resin | (parts) | Resin | (parts) | resin | amide |
| Ex. 1 | 1 | a-1 | 4 | b1-1 | 35 | b2-1 | 65 | — | — |
| Ex. 2 | 2 | a-1 | 6 | b1-1 | 35 | b2-1 | 65 | — | — |
| Ex. 3 | 3 | a-1 | 4 | b1-1 | 35 | b2-1 | 65 | — | — |
| Ex. 4 | 4 | a-1 | 8 | b1-1 | 35 | b2-1 | 65 | — | — |
| Ex. 5 | 5 | a-1 | 4 | b1-1 | 40 | b2-1 | 60 | — | — |
| Ex. 6 | 6 | a-1 | 4 | b1-1 | 15 | b2-1 | 85 | — | — |
| Ex. 7 | 7 | a-1 | 4 | b1-1 | 40 | b2-1 | 60 | — | — |
| Ex. 8 | 8 | a-1 | 4 | b1-1 | 15 | b2-1 | 85 | — | — |
| Ex. 9 | 9 | a-1 | 8 | b1-1 | 40 | b2-1 | 60 | — | — |
| Ex. 10 | 10 | a-1 | 8 | b1-1 | 15 | b2-1 | 85 | — | — |
| Ex. 11 | 11 | a-1 | 1.5 | b1-1 | 35 | b2-1 | 65 | — | — |
| Ex. 12 | 12 | a-1 | 14 | b1-1 | 35 | b2-1 | 65 | — | — |
| Ex. 13 | 13 | a-1 | 4 | b1-2 | 10 | b2-2 | 90 | — | — |
| Ex. 14 | 14 | a-1 | 4 | b1-2 | 14 | b2-2 | 86 | — | — |
| Ex. 15 | 15 | a-1 | 4 | b1-3 | 70 | b2-2 | 30 | — | — |
| Ex. 16 | 16 | a-1 | 4 | b1-3 | 78 | b2-2 | 22 | — | — |
| Ex. 17 | 17 | a-2 | 4 | b1-1 | 35 | b2-1 | 65 | — | — |
| Ex. 18 | 18 | a-3 | 4 | b1-1 | 35 | b2-1 | 65 | — | — |
| Ex. 19 | 19 | a-1 | 1 | b1-1 | 35 | b2-1 | 65 | — | — |
| Ex. 20 | 20 | a-1 | 15 | b1-1 | 35 | b2-1 | 65 | — | — |
| Ex. 21 | 21 | a-4 | 4 | b1-1 | 35 | b2-1 | 65 | — | — |
| Ex. 22 | 22 | a-5 | 4 | b1-1 | 35 | b2-1 | 65 | — | — |
| Ex. 23 | 23 | a-1 | 4 | b1-1 | 35 | b2-3 | 65 | — | — |
| Ex. 24 | 24 | a-1 | 4 | b1-1 | 35 | b2-1 | 65 | — | EBSA |
| | | | | | | | | | (2 parts) |
| Ex. 25 | 25 | a-1 | 4 | b1-1 | 35 | b2-1 | 65 | — | — |
| Ex. 26 | 26 | a-6 | 4 | b1-1 | 35 | b2-1 | 65 | — | — |
| Ex. 27 | 27 | a-1 | 4 | b1-1 | 35 | b2-1 | 65 | c-1 | — |
| | | | | | | | | (10 parts) | |
| Ex. 28 | 28 | a-1 | 4 | b1-1 | 35 | b2-1 | 65 | — | — |
| Ex. 29 | 29 | a-1 | 4 | b1-1 | 35 | b2-1 | 65 | — | — |
| Ex. 30 | 30 | a-1 | 4 | b1-1 | 35 | b2-4 | 65 | — | — |
| Ex. 31 | 31 | a-1 | 4 | b1-1 | 15 | b2-8 | 85 | — | — |
| Comp. | 32 | — | — | b1-1 | 35 | b2-1 | 65 | — | — |
| Ex. 1 | | | | | | | | | |
| Comp. | 33 | a-1 | 4 | b1-1 | 35 | b2-1 | 65 | — | — |
| Ex. 2 | | | | | | | | | |
| Comp. | 34 | a-1 | 4 | b1-1 | 35 | b2-1 | 65 | — | — |
| Ex. 3 | | | | | | | | | |
| Comp. | 35 | a-1 | 6 | b1-1 | 35 | b2-1 | 65 | — | — |
| Ex. 4 | | | | | | | | | |
| Comp. | 36 | a-1 | 4 | b1-1 | 10 | b2-1 | 90 | — | — |
| Ex. 5 | | | | | | | | | |
| Comp. | 37 | a-1 | 4 | b1-1 | 60 | b2-1 | 40 | — | — |
| Ex. 6 | | | | | | | | | |
| Comp. | 38 | a-7 | 4 | b1-1 | 35 | b2-1 | 65 | — | — |
| Ex. 7 | | | | | | | | | |
| Comp. | 39 | a-7 | 4 | b1-1 | 35 | b2-5 | 65 | — | — |
| Ex. 8 | | | | | | | | | |
| Comp. | 40 | a-2 | 6 | b1-1 | 35 | b2-1 | 65 | — | — |
| Ex. 9 | | | | | | | | | |
| Comp. | 41 | a-1 | 4 | b1-1 | 35 | b2-6 | 65 | — | — |
| Ex. 10 | | | | | | | | | |
| Comp. | 42 | a-2 | 4 | b1-1 | 35 | b2-7 | 65 | — | — |
| Ex. 11 | | | | | | | | | |
| Comp. | 43 | a-1 | 4 | — | — | b2-1 | 100 | — | — |
| Ex. 12 | | | | | | | | | |
| Comp. | 44 | a-1 | 4 | b1-1 | 50 | b2-1 | 50 | — | — |
| Ex. 13 | | | | | | | | | |
| Comp. | 45 | a-1 | 0.8 | b1-1 | 35 | b2-1 | 65 | — | — |
| Ex. 14 | | | | | | | | | |
| Comp. | 46 | a-1 | 16 | b1-1 | 35 | b2-1 | 65 | — | — |
| Ex. 15 | | | | | | | | | |

EBSA: N,N′-ethylenebisstearic acid amide

TABLE 6-2

| | | | | | | | | Thickness |
|---|---|---|---|---|---|---|---|---|
| | | | | | Volume | Kneading | Kneading | of kneaded |
| | | Added amount | Added amount | Added amount | average | temperature | temperature | mixture in |
| | | of colorant | of carnauba | of monazo | particle | at kneading | at feeding | cooling |
| | | (P-1) | wax | metal complex | diameter | portion | portion | process |
| | Toner | (parts) | (parts) | (parts) | (μm) | (° C.) | (° C.) | (mm) |
| Ex. 1 | 1 | 14 | 6 | 2 | 7.0 | 120 | 100 | 2.7 |
| Ex. 2 | 2 | 14 | 6 | 2 | 7.0 | 120 | 100 | 2.7 |
| Ex. 3 | 3 | 14 | 6 | 2 | 7.0 | 120 | 100 | 2.3 |
| Ex. 4 | 4 | 14 | 6 | 2 | 7.0 | 120 | 100 | 3.1 |
| Ex. 5 | 5 | 14 | 6 | 2 | 7.0 | 120 | 100 | 2.7 |
| Ex. 6 | 6 | 14 | 6 | 2 | 7.0 | 120 | 100 | 2.7 |
| Ex. 7 | 7 | 14 | 6 | 2 | 7.0 | 120 | 100 | 2.3 |
| Ex. 8 | 8 | 14 | 6 | 2 | 7.0 | 120 | 100 | 2.3 |
| Ex. 9 | 9 | 14 | 6 | 2 | 7.0 | 120 | 100 | 3.0 |
| Ex. 10 | 10 | 14 | 6 | 2 | 7.0 | 120 | 100 | 3.0 |
| Ex. 11 | 11 | 14 | 6 | 2 | 7.0 | 120 | 100 | 2.7 |
| Ex. 12 | 12 | 14 | 6 | 2 | 7.0 | 120 | 100 | 2.7 |
| Ex. 13 | 13 | 14 | 6 | 2 | 7.0 | 120 | 100 | 2.7 |
| Ex. 14 | 14 | 14 | 6 | 2 | 7.0 | 120 | 100 | 2.7 |
| Ex. 15 | 15 | 14 | 6 | 2 | 7.0 | 120 | 100 | 2.7 |
| Ex. 16 | 16 | 14 | 6 | 2 | 7.0 | 120 | 100 | 2.7 |
| Ex. 17 | 17 | 14 | 6 | 2 | 7.0 | 120 | 100 | 2.7 |
| Ex. 18 | 18 | 14 | 6 | 2 | 7.0 | 120 | 100 | 2.7 |
| Ex. 19 | 19 | 14 | 6 | 2 | 7.0 | 120 | 100 | 3.0 |
| Ex. 20 | 20 | 14 | 6 | 2 | 7.0 | 120 | 100 | 2.7 |
| Ex. 21 | 21 | 14 | 6 | 2 | 7.0 | 120 | 100 | 2.7 |
| Ex. 22 | 22 | 14 | 6 | 2 | 7.0 | 120 | 100 | 2.7 |
| Ex. 23 | 23 | 14 | 6 | 2 | 7.0 | 120 | 100 | 2.7 |
| Ex. 24 | 24 | 14 | 6 | 2 | 7.0 | 120 | 100 | 2.7 |
| Ex. 25 | 25 | 14 | 6 | 2 | 7.0 | 120 | 100 | 2.7 |
| | | (p-2) | | | | | | |
| Ex. 26 | 26 | 14 | 6 | 2 | 7.0 | 120 | 100 | 2.7 |
| Ex. 27 | 27 | 14 | 6 | 2 | 7.0 | 120 | 100 | 2.7 |
| Ex. 28 | 28 | 14 | 6 | 2 | 4.4 | 120 | 100 | 2.7 |
| Ex. 29 | 29 | 14 | 6 | 2 (salicylic | 7.0 | 120 | 100 | 2.7 |
| | | | | acid metal | | | | |
| | | | | compound) | | | | |
| Ex. 30 | 30 | 14 | 6 | 2 | 7.0 | 120 | 100 | 2.7 |
| Ex. 31 | 31 | 14 | 6 | 2 | 7.0 | 120 | 100 | 2.7 |
| Comp. | 32 | 14 | 6 | 2 | 7.0 | 120 | 100 | 2.7 |
| Ex. 1 | | | | | | | | |
| Comp. | 33 | 14 | 6 | 2 | 7.0 | 120 | 100 | 1.5 |
| Ex. 2 | | | | | | | | |
| Comp. | 34 | 14 | 6 | 2 | 7.0 | 140 | 120 | 1.0 |
| Ex. 3 | | | | | | | | |
| Comp. | 35 | 14 | 6 | 2 | 7.0 | 140 | 120 | 3.5 |
| Ex. 4 | | | | | | | | |
| Comp. | 36 | 14 | 6 | 2 | 7.0 | 120 | 100 | 2.7 |
| Ex. 5 | | | | | | | | |
| Comp. | 37 | 14 | 6 | 2 | 7.0 | 120 | 100 | 2.7 |
| Ex. 6 | | | | | | | | |
| Comp. | 38 | 14 | 6 | 2 | 7.0 | 120 | 100 | 2.7 |
| Ex. 7 | | | | | | | | |
| Comp. | 39 | 14 | 6 | 2 | 7.0 | 120 | 100 | 1.5 |
| Ex. 8 | | | | | | | | |
| Comp. | 40 | 14 | 6 | 2 | 7.0 | 120 | 100 | 3.5 |
| Ex. 9 | | | | | | | | |
| Comp. | 41 | 14 | 6 | 2 | 7.0 | 120 | 100 | 2.7 |
| Ex. 10 | | | | | | | | |
| Comp. | 42 | 14 | 6 | 2 | 7.0 | 120 | 100 | 2.7 |
| Ex. 11 | | | | | | | | |
| Comp. | 43 | 14 | 6 | 2 | 7.0 | 120 | 100 | 2.7 |
| Ex. 12 | | | | | | | | |
| Comp. | 44 | 14 | 6 | 2 | 7.0 | 120 | 100 | 2.7 |
| Ex. 13 | | | | | | | | |
| Comp. | 45 | 14 | 6 | 2 | 7.0 | 120 | 100 | 2.7 |
| Ex. 14 | | | | | | | | |
| Comp. | 46 | 14 | 6 | 2 | 7.0 | 120 | 100 | 2.7 |
| Ex. 15 | | | | | | | | |

The following properties of the toners 1-46 are shown in Tables 7-1 and 7-2 below.

1. Main peak of the molecular weight distribution curve
2. Half width of the main peak
3. Ratio (C/R) of the height (C) of the peak specific to the crystalline polyester resin (A) to the height (R) of the peak specific to the non-crystalline polyester resin (B) in an attenuated total reflection Fourier transform infrared spectroscopic analysis (ATR-FTIR) performed after the toner is preserved 12 hours at 45° C.
4. Temperature α at which the tan δ curve has an inflection point or a local maximal point
5. Value of tan δ at temperature α
6. Temperature β at which the tan δ curve has a local maximal point
7. Value of tan δ at temperature β
8. DSC peak temperature specific to the crystalline polyester resin (A) in a range of from 90 to 130° C.
9. Endothermic energy amount of DSC peak (J/g)

TABLE 7-1

| | | Main peak of | | Content of | | | Inflection |
|---|---|---|---|---|---|---|---|
| | | molecular | Half | chloroform- | | | point (I) |
| | | weight | width | insoluble | | | or local |
| | | distribution | of main | component | | Temperature | maximal |
| | Toner | curve of toner | peak | (%) | C/R | α (° C.) | point (M) |
| Ex. 1 | 1 | 8,300 | 18,200 | 7.0 | 0.12 | 72.2 | (I) |
| Ex. 2 | 2 | 8,400 | 18,000 | 7.0 | 0.12 | 68.0 | (M) |
| Ex. 3 | 3 | 8,300 | 18,000 | 7.0 | 0.12 | 70.5 | (I) |
| Ex. 4 | 4 | 8,300 | 18,000 | 7.0 | 0.12 | 66.7 | (M) |
| Ex. 5 | 5 | 9,500 | 19,300 | 7.0 | 0.12 | 72.3 | (I) |
| Ex. 6 | 6 | 1,200 | 10,000 | 3.0 | 0.12 | 72.0 | (I) |
| Ex. 7 | 7 | 9,800 | 19,500 | 7.0 | 0.12 | 70.5 | (I) |
| Ex. 8 | 8 | 2,000 | 12,000 | 7.0 | 0.12 | 70.5 | (I) |
| Ex. 9 | 9 | 9,700 | 19,400 | 7.0 | 0.12 | 66.7 | (M) |
| Ex. 10 | 10 | 1,000 | 9,900 | 7.0 | 0.12 | 66.7 | (M) |
| Ex. 11 | 11 | 7,800 | 18,200 | 7.0 | 0.05 | 72.6 | (I) |
| Ex. 12 | 12 | 7,800 | 18,200 | 7.0 | 0.54 | 73.6 | (M) |
| Ex. 13 | 13 | 3,500 | 8,500 | 0.6 | 0.12 | 72.0 | (I) |
| Ex. 14 | 14 | 4,000 | 9,000 | 1.1 | 0.12 | 72.2 | (I) |
| Ex. 15 | 15 | 9,300 | 17,800 | 27.0 | 0.12 | 72.0 | (O) |
| Ex. 16 | 16 | 9,500 | 18,000 | 31.0 | 0.12 | 72.2 | (I) |
| Ex. 17 | 17 | 8,200 | 18,000 | 7.0 | 0.10 | 66.0 | (I) |
| Ex. 18 | 18 | 8,200 | 18,000 | 7.0 | 0.11 | 65.4 | (I) |
| Ex. 19 | 19 | 8,200 | 18,000 | 7.0 | 0.04 | 72.5 | (I) |
| Ex. 20 | 20 | 8,200 | 18,000 | 7.0 | 0.53 | 73.6 | (M) |
| Ex. 21 | 21 | 8,200 | 18,000 | 7.0 | 0.13 | 78.5 | (I) |
| Ex. 22 | 22 | 8,200 | 18,000 | 7.0 | 0.14 | 79.6 | (I) |
| Ex. 23 | 23 | 9,700 | 19,800 | 7.0 | 0.12 | 72.2 | (I) |
| Ex. 24 | 24 | 7,500 | 18,000 | 7.0 | 0.12 | 72.7 | (I) |
| Ex. 25 | 25 | 8,000 | 17,500 | 9.0 | 0.12 | 71.9 | (I) |
| Ex. 26 | 26 | 8,200 | 17,500 | 7.0 | 0.11 | 75.5 | (I) |
| Ex. 27 | 27 | 8,000 | 17,500 | 8.0 | 0.11 | 72.3 | (I) |
| Ex. 28 | 28 | 8,000 | 17,500 | 7.0 | 0.11 | 72.4 | (I) |
| Ex. 29 | 29 | 8,000 | 17,500 | 7.0 | 0.11 | 73.3 | (I) |
| Ex. 30 | 30 | 7,000 | 13,000 | 7.0 | 0.11 | 73.3 | (I) |
| Ex. 31 | 31 | 2,000 | 7,000 | 2.5 | 0.12 | 72.0 | (I) |
| Comp. | 32 | 8,200 | 18,000 | 8.0 | — | No | No |
| Ex. 1 | | | | | | | |
| Comp. | 33 | 8,200 | 18,000 | 8.0 | — | 74.0 | (I) |
| Ex. 2 | | | | | | | |
| Comp. | 34 | 8,200 | 18,000 | 8.0 | — | No | No |
| Ex. 3 | | | | | | | |
| Comp. | 35 | 8,200 | 18,000 | 8.0 | — | 72.4 | (M) |
| Ex. 4 | | | | | | | |
| Comp. | 36 | 900 | 9,000 | 9.0 | 0.12 | 73.0 | (I) |
| Ex. 5 | | | | | | | |
| Comp. | 37 | 11,000 | 20,500 | 10.0 | 0.12 | 72.6 | (I) |
| Ex. 6 | | | | | | | |
| Comp. | 38 | 8,200 | 18,000 | 8.0 | — | 90.5 | (M) |
| Ex. 7 | | | | | | | |
| Comp. | 39 | 9,400 | 19,000 | 8.0 | — | 84.0 | (M) |
| Ex. 8 | | | | | | | |
| Comp. | 40 | 8,200 | 18,000 | 8.0 | — | 62.0 | (M) |
| Ex. 9 | | | | | | | |
| Comp. | 41 | 9,700 | 19,800 | 8.0 | — | 73.0 | (I) |
| Ex. 10 | | | | | | | |
| Comp. | 42 | 8,200 | 16,000 | 8.0 | — | 66.0 | (M) |
| Ex. 11 | | | | | | | |
| Comp. | 43 | 8,200 | 18,000 | 0.0 | 0.12 | 73.0 | (I) |
| Ex. 12 | | | | | | | |
| Comp. | 44 | 11,500 | 21,000 | 6.0 | 0.12 | 73.2 | (I) |
| Ex. 13 | | | | | | | |
| Comp. | 45 | 8,200 | 18,000 | 7.0 | 0.02 | 73.7 | (I) |
| Ex. 14 | | | | | | | |
| Comp. | 46 | 8,200 | 18,000 | 7.0 | 0.58 | 73.4 | (M) |
| Ex. 15 | | | | | | | |

TABLE 7-2

| | | | | | | Endothermic |
|---|---|---|---|---|---|---|
| | | Value of | Temperature | Value of | DSC peak | energy amount |
| | | tanδ at | β | tanδ at | temperature | of DSC peak |
| | Toner | temp. α | (° C.) | temp. β | (° C.) | (J/g) |
| Ex. 1 | 1 | 1.42 | 82.0 | 1.56 | 108 | 5.0 |
| Ex. 2 | 2 | 1.75 | 82.5 | 1.67 | 108 | 5.0 |
| Ex. 3 | 3 | 1.22 | 81.8 | 1.55 | 108 | 5.0 |
| Ex. 4 | 4 | 1.92 | 82.0 | 1.58 | 108 | 5.0 |
| Ex. 5 | 5 | 1.45 | 83.1 | 1.05 | 108 | 5.0 |
| Ex. 6 | 6 | 1.44 | 82.3 | 2.43 | 108 | 5.0 |
| Ex. 7 | 7 | 1.23 | 83.5 | 1.04 | 108 | 5.0 |
| Ex. 8 | 8 | 1.21 | 82.3 | 2.44 | 108 | 5.0 |
| Ex. 9 | 9 | 1.95 | 83.2 | 1.08 | 108 | 5.0 |
| Ex. 10 | 10 | 1.96 | 82.4 | 2.46 | 108 | 5.0 |
| Ex. 11 | 11 | 1.25 | 82.6 | 1.59 | 108 | 1.3 |
| Ex. 12 | 12 | 1.92 | 82.9 | 1.56 | 108 | 14.0 |
| Ex. 13 | 13 | 1.42 | 82.3 | 2.16 | 108 | 5.0 |
| Ex. 14 | 14 | 1.46 | 83.1 | 1.95 | 108 | 5.0 |
| Ex. 15 | 15 | 1.40 | 82.0 | 1.24 | 108 | 5.0 |
| Ex. 16 | 16 | 1.48 | 82.1 | 1.15 | 108 | 5.0 |
| Ex. 17 | 17 | 1.43 | 82.2 | 1.50 | 88 | 5.0 |
| Ex. 18 | 18 | 1.41 | 82.7 | 1.58 | 92 | 5.0 |
| Ex. 19 | 19 | 1.20 | 82.6 | 1.59 | 108 | 0.8 |
| Ex. 20 | 20 | 1.98 | 82.9 | 1.56 | 108 | 16.0 |
| Ex. 21 | 21 | 1.39 | 82.7 | 1.58 | 127 | 5.0 |
| Ex. 22 | 22 | 1.41 | 82.7 | 1.58 | 131 | 5.0 |
| Ex. 23 | 23 | 1.48 | 84.0 | 1.28 | 108 | 5.0 |
| Ex. 24 | 24 | 1.48 | 83.0 | 1.58 | 108 | 5.0 |
| Ex. 25 | 25 | 1.50 | 82.5 | 1.55 | 108 | 5.0 |
| Ex. 26 | 26 | 1.52 | 82.3 | 1.51 | 110 | 5.0 |
| Ex. 27 | 27 | 1.44 | 82.9 | 1.54 | 110 | 5.0 |
| Ex. 28 | 28 | 1.48 | 83.1 | 1.52 | 110 | 5.0 |
| Ex. 29 | 29 | 1.49 | 82.6 | 1.55 | 110 | 5.0 |
| Ex. 30 | 30 | 1.49 | 82.6 | 1.55 | 110 | 5.0 |
| Ex. 31 | 31 | 1.49 | 81.0 | 2.30 | 108 | 5.0 |
| Comp. | 32 | No | 82.6 | 1.59 | — | — |
| Ex. 1 | | | | | | |
| Comp. | 33 | 1.10 | 83.1 | 1.52 | 108 | 5.0 |
| Ex.2 | | | | | | |
| Comp. | 34 | No | 83.1 | 1.50 | 108 | 5.0 |
| Ex.3 | | | | | | |
| Comp. | 35 | 2.10 | 82.9 | 1.56 | 108 | 5.0 |
| Ex. 4 | | | | | | |
| Comp. | 36 | 1.55 | 82.3 | 2.55 | 108 | 5.0 |
| Ex. 5 | | | | | | |
| Comp. | 37 | 1.47 | 83.1 | 0.93 | 108 | 5.0 |
| Ex. 6 | | | | | | |
| Comp. | 38 | 1.60 | 83.0 | 1.50 | 108 | 5.0 |
| Ex. 7 | | | | | | |
| Comp. | 39 | 1.60 | 87.5 | 1.50 | 128 | 4.8 |
| Ex. 8 | | | | | | |
| Comp. | 40 | 1.72 | 82.8 | 1.53 | 108 | 5.0 |
| Ex. 9 | | | | | | |
| Comp. | 41 | 1.47 | 91.0 | 1.42 | 128 | 5.0 |
| Ex. 10 | | | | | | |
| Comp. | 42 | 1.78 | 73.5 | 1.84 | 128 | 5.0 |
| Ex. 11 | | | | | | |
| Comp. | 43 | 1.55 | 82.3 | 2.80 | 108 | 5.0 |
| Ex. 12 | | | | | | |
| Comp. | 44 | 1.47 | 83.1 | 0.88 | 108 | 5.0 |
| Ex. 13 | | | | | | |
| Comp. | 45 | 1.15 | 82.9 | 1.53 | 108 | 0.6 |
| Ex. 14 | | | | | | |
| Comp. | 46 | 2.08 | 83.0 | 1.55 | 108 | 17.0 |
| Ex. 15 | | | | | | |

The toner 1 of Example 1 had such a viscoelastic curve as illustrated in FIG. 1, and the toner 2 of Example 2 had such a viscoelastic curve as illustrated in FIG. 2. The toner 32 of Comparative Example 1 had such a viscoelastic curve as illustrated in FIG. 3 in which the curve has only one local maximal point.

Each of the developers 1-46 respectively including the toners 1-46 was set in the developing unit 105D of the image forming apparatus illustrated in FIG. 9 to evaluate the below-mentioned image qualities of the toner. In this regard, the developing units 105A-105C were not used.

### 1. Low Temperature Fixability and Hot Offset Resistance

A solid image having a toner weight of 0.4 mg/cm² was formed on a recording paper TYPE 6200 from Ricoh Co., Ltd. by performing the charging, irradiating, developing and transferring processes, and the solid toner image was fixed at a fixing speed of 180 mm/sec. In this regard, the fixing temperature was changed at intervals of 5° C., and the width of the fixing nip formed by the fixing roller 109 and the pressure roller 109A was 11 mm. The output solid images were visually observed to determine the minimum fixable temperature above which the solid image can be satisfactorily fixed without causing the cold offset problem, and the maximum fixable temperature below which the solid image can be satisfactorily fixed without causing the hot offset problem. Thus, the low temperature fixability, and hot offset resistance of the toner were evaluated.

### 1-1 Evaluation of Low Temperature Fixability

The low temperature fixability was graded as follows.

⊚: The minimum fixable temperature is lower than 130° C. (Excellent)
◯: The minimum fixable temperature is not lower than 130° C. and lower than 140° C. (Good)
□: The minimum fixable temperature is not lower than 140° C. and lower than 150° C. (Fair)
Δ: The minimum fixable temperature is not lower than 150° C. and lower than 160° C. (Usable)
X: The minimum fixable temperature is not lower than 160° C. (Unusable)
1-2 Hot offset resistance

The hot offset resistance was graded as follows.

⊚: The hot offset temperature is not lower than 200° C. (Excellent)
◯: The hot offset temperature is not lower than 190° C. and lower than 200° C. (Good)
□: The hot offset temperature is not lower than 180° C. and lower than 190° C. (Fair)
Δ: The hot offset temperature is not lower than 170° C. and lower than 180° C. (Usable)
X: The hot offset temperature is lower than 170° C. (Unusable)

### 2. High Temperature Preservability

Ten (10) grams of each toner was fed into a 30 ml screw vial container, and the container was tapped 100 times using a tapping machine. The screw vial container containing the toner was allowed to settle for 24 hours in a chamber which was controlled to have a temperature of 50° C. and a relative humidity of 70% RH. After the screw vial container was cooled to room temperature, the toner in the screw vial container was subjected to a penetration test using a penetration tester to evaluate the high temperature preservability of the toner.

The high temperature preservability was graded as follows.

⊚: The needle of the penetration tester passes through the toner layer. (Excellent)
◯: The penetration length of the needle is not less than 20 mm. (Good)
□: The penetration length of the needle is not less than 15 mm and less than 20 mm. (Fair)
Δ: The penetration length of the needle is not less than 10 mm and less than 15 mm. (Usable)
X: The penetration length of the needle is less than 10 mm. (Unusable)

### 3. Background Development and Toner Scattering

A running test in which 100,000 copies of a chart with an image area proportion of 5% are continuously produced while the toner is supplied to the developing device was performed using the image forming apparatus illustrated in FIG. 9. After the running test, a copy of a character image chart with an image area proportion of 5% which includes characters with a size of 2 mm×2 mm was output. The copy was visually observed to determine whether the copy has background development (i.e., whether the background of the character image is soiled with the toner). In addition, after the running test, the developing device and the vicinity thereof were visually observed to determine whether the developing device and the vicinity thereof are soiled with the toner (i.e., whether the toner is scattered around the developing device.

### 3-1 Evaluation of Background Development

The background development was graded as follows.

⊚: The background development property is of an excellent level.
◯: The background development property is of a good level.
□: The background development property is of a middle level.
Δ: The background development property is of a usable level.
X: The background development property is of an unusable level.
3-1 Evaluation of toner scattering
⊚: The toner scattering property is of an excellent level.
◯: The toner scattering property is of a good level.
□: The toner scattering property is of a middle level.
Δ: The toner scattering property is of a usable level.
X: The toner scattering property is of an unusable level.

The evaluation results are shown in Table 8 below.

TABLE 8

| | | Low | | High | | |
|---|---|---|---|---|---|---|
| | | temperature | Hot offset | temperature | Background | Toner |
| | Toner | fixability | resistance | preservability | development | scattering |
| Ex. 1 | 1 | ⊚ | ◯ | ◯ | ◯ | ◯ |
| Ex. 2 | 2 | ⊚ | ◯ | ◯ | ◯ | ◯ |
| Ex. 3 | 3 | ◯ | ◯ | ⊚ | ◯ | ◯ |
| Ex. 4 | 4 | ⊚ | ◯ | Δ | ◯ | ◯ |
| Ex. 5 | 5 | Δ | ◯ | ◯ | ◯ | ◯ |
| Ex. 6 | 6 | ◯ | Δ | ◯ | ◯ | ◯ |
| Ex. 7 | 7 | Δ | ⊚ | ⊚ | ◯ | ◯ |
| Ex. 8 | 8 | Δ | Δ | ⊚ | ◯ | ◯ |
| Ex. 9 | 9 | ⊚ | ⊚ | ◯ | ◯ | ◯ |
| Ex. 10 | 10 | ⊚ | Δ | Δ | ◯ | ◯ |
| Ex. 11 | 11 | Δ | ◯ | ⊚ | ◯ | ◯ |
| Ex. 12 | 12 | ⊚ | ◯ | Δ | ◯ | ◯ |
| Ex. 13 | 13 | ⊚ | Δ | Δ | ◯ | ◯ |
| Ex. 14 | 14 | ⊚ | □ | Δ | ◯ | ◯ |
| Ex. 15 | 15 | □ | ⊚ | ⊚ | ◯ | ◯ |
| Ex. 16 | 16 | Δ | ⊚ | ⊚ | ◯ | ◯ |
| Ex. 17 | 17 | ◯ | Δ | Δ | ◯ | ◯ |
| Ex. 18 | 18 | ◯ | □ | □ | ◯ | ◯ |
| Ex. 19 | 19 | ◯ | ◯ | Δ | ◯ | ◯ |
| Ex. 20 | 20 | ⊚ | ◯ | Δ | ◯ | ◯ |
| Ex. 21 | 21 | □ | ◯ | ◯ | ◯ | ◯ |
| Ex. 22 | 22 | Δ | ◯ | ◯ | ◯ | ◯ |
| Ex. 23 | 23 | Δ | □ | □ | ◯ | ◯ |
| Ex. 24 | 24 | ⊚ | ⊚ | ◯ | ◯ | ◯ |
| Ex. 25 | 25 | ⊚ | □ | ◯ | ◯ | ◯ |
| Ex. 26 | 26 | ◯ | ◯ | ◯ | ◯ | ◯ |
| Ex. 27 | 27 | ⊚ | ◯ | ⊚ | ⊚ | ⊚ |
| Ex. 28 | 28 | ⊚ | ◯ | ◯ | □ | □ |
| Ex. 29 | 29 | ◯ | ◯ | ◯ | □ | □ |
| Ex. 30 | 30 | ⊚ | ◯ | ⊚ | ◯ | ◯ |
| Ex. 31 | 31 | ⊚ | Δ | Δ | ◯ | ◯ |
| Comp. | 32 | X | ◯ | Δ | Δ | Δ |
| Ex. 1 | | | | | | |
| Comp. | 33 | X | ◯ | Δ | Δ | Δ |
| Ex. 2 | | | | | | |
| Comp. | 34 | X | ◯ | ⊚ | Δ | Δ |
| Ex. 3 | | | | | | |
| Comp. | 35 | ⊚ | X | X | X | Δ |
| Ex. 4 | | | | | | |
| Comp. | 36 | ⊚ | X | X | □ | □ |
| Ex. 5 | | | | | | |
| Comp. | 37 | X | ◯ | ◯ | Δ | Δ |
| Ex. 6 | | | | | | |
| Comp. | 38 | X | ◯ | ◯ | ◯ | ◯ |
| Ex. 7 | | | | | | |
| Comp. | 39 | X | Δ | ⊚ | ◯ | ◯ |
| Ex. 8 | | | | | | |
| Comp. | 40 | ⊚ | Δ | X | X | X |
| Ex. 9 | | | | | | |
| Comp. | 41 | X | ◯ | ◯ | ◯ | ◯ |
| Ex. 10 | | | | | | |
| Comp. | 42 | ⊚ | X | X | Δ | Δ |
| Ex. 11 | | | | | | |
| Comp. | 43 | ⊚ | X | X | Δ | Δ |
| Ex. 12 | | | | | | |
| Comp. | 44 | X | ◯ | ◯ | ◯ | ◯ |
| Ex. 13 | | | | | | |
| Comp. | 45 | X | ◯ | ⊚ | ⊚ | ⊚ |
| Ex. 14 | | | | | | |
| Comp. | 46 | ⊚ | ◯ | X | X | X |
| Ex. 15 | | | | | | |

It is clear from Table 8 that the toners of Examples 1-31 have a good combination of low temperature fixability, hot offset resistance and high temperature preservability, and can produce high quality images over a long period of time.

As mentioned above, the toner of this disclosure has a good combination of low temperature fixability, hot offset resistance, and preservation stability and can produce high quality images over a long period of time. In addition, the image forming method and apparatus, and the process cartridge of this disclosure can produce high quality images over a long period of time.

Additional modifications and variations of the present invention are possible in light of the above teachings. It is therefore to be understood that within the scope of the appended claims the invention may be practiced other than as specifically described herein.

What is claimed is:

1. A toner comprising:
a crystalline polyester resin (A); and
a non-crystalline resin (B),
wherein the toner includes a tetrahydrofuran-soluble component and a chloroform-insoluble component, and
wherein the toner has an infrared absorption property such that when the toner is preserved for 12 hours at 45° C. and then subjected to an attenuated total reflection Fourier transform infrared spectroscopic analysis (ATR-FTIR), a ratio (C/R) of a height (C) of a peak specific to the crystalline polyester resin (A) to a height (R) of another peak specific to the non-crystalline polyester resin (B) is from 0.03 to 0.55; a molecular weight distribution property such that the tetrahydrofuran-soluble component of the toner has a molecular weight distribution curve obtained by gel permeation chromatography (GPC) such that a main peak is present in a range of from 1,000 to 10,000, and a half width of the main peak is not greater than 20,000; and a viscoelastic property such that a curve of loss tangent (tan δ) defined as a ratio (G″/G′) of loss elastic modulus (G″) to storage elastic modulus (G′) has at least an inflection point or a local maximal point at a temperature α in a temperature range of from 65° C. to 80° C. while having a local maximal point at a temperature β in a temperature range of from 75° C. to 90° C., wherein a value of the loss tangent at the temperature α is from 1.2 to 2.0, and a value of the loss tangent at the temperature β is from 1.0 to 2.5, wherein the temperature α is lower than the temperature β.

2. The toner according to claim 1, wherein the toner includes the chloroform-insoluble component in an amount of from 1 to 30% by weight based on a weight of the toner.

3. The toner according to claim 1, wherein the half width of the main peak of the molecular weight distribution curve is not greater than 15,000.

4. The toner according to claim 1, wherein the toner is a pulverization toner prepared by a method including melting and kneading toner components including at least the crystalline polyester resin (A) and the non-crystalline resin (B) to prepare a kneaded toner component mixture, and pulverizing the kneaded toner component mixture.

5. The toner according to claim 1, wherein the toner has a differential scanning calorimetric (DSC) property such that an endothermic peak is observed in a temperature range of from 90 to 130° C., and an endothermic energy amount of the endothermic peak is from 1 to 15 J/g.

6. The toner according to claim 1, wherein the non-crystalline resin (B) includes a non-crystalline resin (B-1) including a chloroform-insoluble component, and another non-crystalline resin (B-2).

7. The toner according to claim 6, wherein the non-crystalline resin (B-1) includes a chloroform-insoluble component in an amount of from 5 to 40% by weight based on a weight of the non-crystalline resin (B-1).

8. The toner according to claim 6, wherein a tetrahydrofuran-soluble component of the non-crystalline resin (B-2) has a molecular weight distribution curve obtained by gel permeation chromatography (GPC) such that a main peak is present in a range of from 1,000 to 10,000, and a half width of the main peak is not greater than 20,000.

9. The toner according to claim 1, wherein the non-crystalline resin (B) includes a non-crystalline resin (B-1) and another non-crystalline resin (B-2), and wherein the non-crystalline resin (B-1) has a softening point (T1/2) at least 25° C. higher than a softening point of the non-crystalline resin (B-2).

10. The toner according to claim 1, further comprising:
a fatty acid amide compound.

11. The toner according to claim 1, wherein the crystalline polyester resin (A) has an ester bond having the following formula (1) in a main chain thereof:
[—OCO—R—COO—(CH₂)ₙ—] (1),
wherein R represents an unsaturated linear hydrocarbon group having 2 to 20 carbon atoms, and n is an integer of from 2 to 20.

12. An image forming method comprising:
forming an electrostatic latent image on an image bearing member; and
developing the electrostatic latent image with a developer including the toner according to claim 1 to prepare a toner image on the image bearing member.

13. An image forming apparatus comprising:
an image bearing member;
a charger to charge a surface of the image bearing member;
an irradiator to irradiate the charged surface of the image bearing member with light to form an electrostatic latent image on the image bearing member;
a developing device to develop the electrostatic latent image with a developer including the toner according to claim 1 to form a toner image on the image bearing member; and
a transferring device to transfer the toner image to a recording medium.

14. A process cartridge comprising:
an image bearing member to bear an electrostatic latent image thereon; and
a developing device to develop the electrostatic latent image with a developer including the toner according to claim 1 to form a toner image on the image bearing member,
wherein the image bearing member and the developing device are integrated as a unit so as to be detachably attachable to an image forming apparatus.
